(19) United States
(12) Patent Application Publication
(10) Pub. No.: US 2007/0158193 A1
(43) Pub. Date: Jul. 12, 2007

(54) Analyte Identification in Transformed Electropherograms

(76) Inventors: Dean Burgi, South San Francisco, CA (US); Stephen Williams, South San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/462,990

(22) Filed: Aug. 7, 2006

Related U.S. Application Data
(63) Continuation of application No. 10/726,321, filed on Dec. 1, 2003, now abandoned.

(51) Int. Cl. B01D 57/02; G01N 27/00

(52) U.S. Cl. 204/452; 204/603

(57) ABSTRACT

The present invention is directed to methods for identifying one or more analytes in a sample using electrophoresis. In one embodiment, the method comprises performing an electrophoretic separation by applying a potential across the separation path and thus generating a current and power therein and producing an electropherogram, integrating the current or the power to determine the cumulative current or power as a function of the separation time, transforming the electropherogram to a second electropherogram representing the signal as a function of the cumulative current or power, and identifying in the second electropherogram peaks that are correlated with the analytes in the sample. The invention also provides systems for performing the analysis and identification methods, as well as computer-readable products for performing the steps associated with the above methods.

### FIELD OF THE INVENTION

This invention relates to a method and a system for detecting and/or measuring one or more analytes in a sample by electrophoretic separation, and more particularly, to methods for analyzing data generated by an electrophoretic separation.

### BACKGROUND OF THE INVENTION

Separation by electrophoresis is a widely used analytical and preparative technique, especially in the life sciences. Electrophoretic separation is based on the movement of charged analytes in solution under the influence of an electric field. The rate of migration of an analyte depends on the size and shape of the analyte, the charge carried, the applied voltage and the resistance of the separation medium, Rickwood and Hames, Gel Electrophoresis of Nucleic Acids: A Practical Approach (IRL Press, Oxford, 1982). Many variations of the technique have been developed depending on the class of analyte being examined, e.g. DNA, proteins, small molecule drugs, and the like. In particular, capillary electrophoresis has developed into an important analytical technique that finds wide applications in DNA sequencing technologies, quality control systems, forensics, and the like, for measuring many different kinds of analytes, including, polynucleotides, proteins, and small organic molecules.

The popularity of capillary electrophoresis is based on several important technical advantages: (i) capillaries have high surface-to-volume ratios which permit more efficient heat dissipation which, in turn, permit the application of high electric fields for more rapid separations; (ii) the technique requires minimal sample volumes; (iii) high resolution of most analytes is attainable; and (iv) the technique is amenable to automation, e.g. Camilleri, editor, Capillary Electrophoresis: Theory and Practice (CRC Press, Boca Raton, 1993); Grossman et al, editors, Capillary Electrophoresis (Academic Press, San Diego, 1992); and Landers, editor, Handbook of Capillary Electrophoresis, Second Edition (CRC Press, Boca Raton, 1997).

The results of electrophoretic analysis are frequently provided as an electropherogram that depicts a record of signal intensity values versus time, or versus position in some cases. That is, an electropherogram is a graphical representation of signal intensity as a function of time or position. The data in an electropherogram may be collected in a variety of ways, depending on the type of electrophoretic technique employed and the type of signal detected. In many electrophoretic systems, a signal is collected at a particular station along the separation path, as shown in FIG. 1A, which is a diagram illustrating the main components of a capillary electrophoresis system. In a successful separation, sample constituents form distinct peaks of various heights and widths in an electropherogram.

A problem often encountered with electrophoresis is that the same sample constituents may appear on an electropherogram at different migration times for different samples of the same kind. That is, a constituent, or analyte, common to two different samples may appear at a different place on each of the electropherograms for such samples. Factors that contribute to such variability include changes in the migration rates of the constituents caused by changes in the local environments of the analytes during a separation, perhaps caused by the introduction of the sample itself. That is, the process of separating multiple constituents of a sample from one another can affect the local conductivity of the separation medium around the constituents; and hence, their migration rates.

This creates a difficulty in many analytical procedures since analytes are typically identified either (i) by the appearance of a peak of a particular size or position on an electropherogram relative to the peaks of other sample constituents or relative to the peak(s) of a standard or (ii) by a characteristic migration time under predetermined separation conditions. In either case, local variations in analyte migration rates reduce the accuracy of such identification. These difficulties can be particularly troublesome in the separation of complex samples, where large numbers of analytes are sought to be identified in a single separation path, such as fragment ladders in DNA sequencing, and multiplexed analytical techniques, e.g. Singh et al, International patent publications WO 00/66607; WO 01/83502; WO 02/95356; WO 03/06947; and U.S. Pat. Nos. 6,322,980 and 6,514,700.

Performing electrophoretic separations at constant power provides one means of improving temperature uniformity and reducing fluctuations and variations in the migration rates. However, the majority of commercial electrophoresis instruments, particularly those for capillary electrophoresis operate in constant voltage mode. In these cases the end-user has no recourse for improving the analytical performance via the hardware.

In view of the above, the availability of a convenient method for accounting for and correcting the affects of varying analyte migration rates would advance many fields where electrophoretic separations are important, including life science research, medical research and diagnostics, forensics, and the like.

### SUMMARY OF THE INVENTION

The present invention is directed to a method, system and product for identifying one or more analytes in a sample using electrophoresis. In one aspect, the method comprises the steps of (a) applying a potential across a separation path containing one or more analytes to generate a current therein and to produce an electropherogram of the one or more analytes, (b) integrating the current to determine the cumulative current as a function of the separation time, (c) transforming the electropherogram to a second electropherogram representing the signal as a function of the cumulative current, and (d) identifying in the second electropherogram peaks that are correlated with the analytes in the sample.

In another aspect, the method comprises the steps of performing an electrophoretic separation by applying a potential across the separation path containing one or more analytes thereby generating an electrical power therein and producing an electropherogram, integrating the power to determine the cumulative power as a function of the separation time, transforming the electropherogram to a second electropherogram representing the signal as a function of the cumulative power, and identifying in the second electropherogram peaks that are correlated with the analytes in the sample.

In yet another aspect, a plurality of separation paths is provided for the identification of one or more analytes in a plurality of samples. In one embodiment, a potential is applied independently across each of the plurality of separation paths, and in another embodiment a potential is applied jointly across the entire plurality of separation paths. In either embodiment, electropherograms are produced for each separation path, the current is each path is integrated to provide the cumulative current as a function of time for each path, each electropherogram is transformed to a respective second electropherogram representing the signal as a function of the cumulative current, and finally peaks in the second electropherograms are identified by correlation with the analytes in the samples.

In another aspect, the invention provides a method for identifying analytes in a sample separated by electrophoresis to give a first data set of a signal as a function of time and a data set of the separation path power or current as a function of time, wherein the method comprises the steps of integrating the separation path parameter (power or current) with respect to time to provide a cumulative parameter as a function of time, transforming the first signal data to a second data set of the signal as a function of the cumulative parameter (power or current), and identifying in the second data set peaks correlated with the analytes in the sample.

In another aspect, the invention provides a system for performing the above methods. In one embodiment, the system comprises a separation path comprising a separation medium, a voltage source for applying a potential across the length of the separation path wherein a current and power are generated, a detector positioned along the separation path for recording a first electropherogram of the signal intensity associated with the analytes as a function of the separation time, and a processor comprising software for (a) integrating with respect to the separation time the current in the separation path to provide the cumulative current as a function of time; (b) transforming the first electropherogram to a second electropherogram of the signal intensity associated with the analytes as a function of the cumulative current; and (c) identifying in the second electropherogram peaks that are correlated with the analytes in the separation path.

In any of the aforementioned embodiments the separation path may comprise a capillary tube, capillary channel, microfluidic channel, or the like, as typically found in systems known and disclosed in the art. Automated capillary array electrophoresis instruments are a convenient means for performing the electrophoretic separation. Also, in another aspect of the aforementioned embodiments, the samples further comprise at least one electrophoretic mobility standard.

In another aspect, the invention provides computer-readable products for performing steps of the above methods.

In any embodiment of the invention, the one or more analytes may be molecular tags, wherein each tag has a different electrophoretic mobility, wherein the presence of the molecular tags in the sample is the result of a specific recognition event with at least one type of molecule selected from the group of proteins, antigens, receptors, DNA and RNA, and wherein the number of types of such molecular tags range from 2 to 50.

The present invention provides a method, system and product for identifying, detecting or measuring one or more analytes that has several advantages over current techniques including, but not limited to, (1) accurate detection and quantification of peaks in electropherogram data, and (2) consistent electrophoretic analyses to overcome run-to-run, channel-to-channel and instrument-to-instrument variation, by correcting for fluctuations in the separation conditions that would otherwise cause fluctuations in the observed migration times or distances of analytes. The invention may also be employed to up-grade existing instruments for electrophoresis to give them the favorable properties of a constant power separation instrument without the need for expensive hardward alterations.

### BRIEF DESCRIPTION OF THE DRAWINGS

FIG. 1A is a diagram illustrating the main components of an instrument for conducting capillary electrophoresis.

FIG. 1B is a diagram illustrating the main components of a system for conducting slab gel electrophoresis.

FIGS. 1C through 1E illustrate steps in practicing an electrophoretic separation using a microfluidics capillary electrophoresis (CE) device.

FIG. 2A is a flow chart illustrating the steps of an embodiment of the invention for identifying analytes in an electrophoretic separation.

FIGS. 2B and 2C are illustrations of embodiments of a system for performing the invention.

FIG. 2D illustrates the component functions of a computer-readable product for performing the invention.

FIGS. 3A through 3K illustrate features of a peak identification algorithm for use with the invention.

FIG. 4 is a flow chart illustrating the steps of an algorithm for identifying peaks in electropherogram data.

FIG. 5A illustrates an exemplary multiplexed assay for detecting or measuring target analytes, such as proteins, by generating molecular tags in a “sandwich” type of assay using antibodies as binding compounds.

FIG. 5B illustrates an exemplary multiplexed assay for detecting or measuring target polynucleotides by generating molecular tags in a “taqman” type of assay in a polymerase chain reaction (PCR).

FIG. 5C illustrates an exemplary multiplexed assay for detecting or measuring target polynucleotides by generating molecular tags in an Invader type of assay.

FIGS. 6A and 6B illustrate the chemical formulas of ten molecular tags.

FIG. 7A shows a set of electropherograms of signal versus time.

FIG. 7B shows the data of FIG. 7A as a set of electropherograms of signal versus relative migration time with respect to electrophoretic standards.

FIG. 7C shows the data of FIG. 7A as a set of electropherograms transformed according to one embodiment of the invention.

FIG. 8 is an electropherogram showing peaks identified according to molecular tag and associated analyte.

### DEFINITIONS

“Analyte” in the present specification and claims is used in a broad sense. On the one hand, the term means a substance, compound, or component in a sample whose presence or absence is to be detected or whose quantity is to be measured in an assay. In such a case, “target” may be used interchangeably with “analyte”. Analytes include but are not limited to peptides, proteins, polynucleotides, polypeptides, oligonucleotides, organic molecules, haptens, epitopes, parts of biological cells, posttranslational modifications of proteins, receptors, complex sugars, vitamins, hormones, and the like. There may be more than one analyte associated with a single molecular entity, e.g. different phosphorylation sites on the same protein, different SNP's within a gene, etc. On the other hand, “analyte” is also used to mean the components of a sample that are subjected to electrophoretic separation analysis. The one or more components, or “analytes” of a sample are separated and detected by the analysis. In one aspect of the present invention, the common terms are linked in the following manner: an assay is performed on a biological “sample” to test for the presence or amount of one or more “analytes” (targets) by employing analyte-specific probes labeled with molecular tags. In the assay reaction, the binding of probe to analyte is followed by the release of the molecular tags. The result of the assay is determined by electrophoresis using a “sample” of the assay solution to determine the presence or amount of the molecular tag “analytes” as found in the electropherogram. Because the composition of the analyte-specific probes labeled with molecular tags are known, the presence of a certain molecular tag “analyte” in an electropherogram directly correlates with the presence of the targeted biological “analyte” in the sample.

“Antibody” means an immunoglobulin that specifically binds to, and is thereby defined as complementary with, a particular spatial and polar organization of another molecule. The antibody can be monoclonal or polyclonal and can be prepared by techniques that are well known in the art such as immunization of a host and collection of sera (polyclonal) or by preparing continuous hybrid cell lines and collecting the secreted protein (monoclonal), or by cloning and expressing nucleotide sequences or mutagenized versions thereof coding at least for the amino acid sequences required for specific binding of natural antibodies. Antibodies may include a complete immunoglobulin or fragment thereof, which immunoglobulins include the various classes and isotypes, such as IgA, IgD, IgE, IgG1, IgG2a, IgG2b and IgG3, IgM, etc. Fragments thereof may include Fab, Fv and F(ab′)2, Fab′, and the like. In addition, aggregates, polymers, and conjugates of immunoglobulins or their fragments can be used where appropriate so long as binding affinity for a particular polypeptide is maintained.

“Antibody binding composition” means a molecule or a complex of molecules that comprise one or more antibodies and derives its binding specificity from an antibody. Antibody binding compositions include, but are not limited to, antibody pairs in which a first antibody binds specifically to a target molecule and a second antibody binds specifically to a constant region of the first antibody; a biotinylated antibody that binds specifically to a target molecule and streptavidin derivatized with moieties such as molecular tags or photosensitizers; antibodies specific for a target molecule and conjugated to a polymer, such as dextran, which, in turn, is derivatized with moieties such as molecular tags or photosensitizers; antibodies specific for a target molecule and conjugated to a bead, or microbead, or other solid phase support, which, in turn, is derivatized with moieties such as molecular tags or photosensitizers, or polymers containing the latter.

“Binding compound” means any molecule to which molecular tags can be directly or indirectly attached that is capable of specifically binding to a membrane-associated analyte. Binding compounds include, but are not limited to, antibodies, antibody binding compositions, peptides, proteins, particularly secreted proteins and orphan secreted proteins, nucleic acids, and organic molecules having a molecular weight of up to 1000 daltons and consisting of atoms selected from the group consisting of hydrogen, carbon, oxygen, nitrogen, sulfur, and phosphorus.

“Capillary” refers to a tube or channel or other structure capable of supporting a volume of separation medium for carrying out electrophoresis. The geometry of a capillary may vary widely and includes tubes with circular, semi-circular, rectangular or square cross-sections, channels, grooves, plates and the like, and may be fabricated by a wide range of technologies. An important feature of a capillary for use with the invention is the surface-to-volume ratio of the surface in contact with the volume of separation medium. High values of this ratio permit better heat transfer from the separation medium during electrophoresis. Preferably, capillaries for use with the invention are made of silica, fused silica, quartz, silicate-based glass, such as borosilicate glass, phosphate glass, and the like, or other silica-like materials.

“Capillary-sized” in reference to a separation column means a capillary tube or channel in a plate or microfluidics device, where the diameter or largest dimension of the separation column is between about 25-500 microns, allowing efficient heat dissipation throughout the separation medium, with consequently low thermal convection within the medium.

“Computer-readable product” means any tangible medium for storing information that can be read by or transmitted into a computer. Computer-readable products include, but are not limited to, magnetic diskettes, magnetic tapes, magnetic disks, optical disks, CD-ROMs, DVDs, flash memory devices, punched tape or cards, read-only memory devices, direct access storage devices, gate arrays, electrostatic memory, and any other like medium.

“Electropherogram” in reference to the separation of analytes, molecular tags and the like means a chart, graph, curve, bar graph, or other representation of signal intensity data versus a parameter related to the separation process, such as time, cumulative current, cumulative power and the like, that provides a readout, or measure, of the number of molecular tags of each type produced in an assay. A “peak” or a “band” or a “zone” in reference to an electropherogram means a region where signal intensity values are high, e.g. relative to background, and correspond to a local concentration of a separated compound. The value of the time parameter where a “peak” or “band” occurs is typically referred to as the “migration time” of that peak. There may be multiple separation profiles for a single assay, for example, if molecular tags are labeled with fluorescent dyes and data is collected and recorded at multiple wavelengths. Thus, molecular tags or electrophoretic standards that have nearly identical electrophoretic mobilities may have distinct peaks in electropherogram data because they are labeled with different dyes. In one aspect, released molecular tags are separated by differences in electrophoretic mobility to form an electropherogram wherein different molecular tags correspond to distinct peaks on the electropherogram. A measure of the distinctness, or lack of overlap, of adjacent peaks in an electropherogram is “electrophoretic resolution,” which may be taken as the distance between adjacent peak maximums divided by four times the larger of the two standard deviations of the peaks. Preferably, adjacent peaks have a resolution of at least 1.0, and more preferably, at least 1.5, and most preferably, at least 2.0. In a given separation and detection system, the desired resolution may be obtained by selecting a plurality of molecular tags whose members have electrophoretic mobilities that differ by at least a peak-resolving amount, such quantity depending on several factors well known to those of ordinary skill, including signal detection system, nature of the fluorescent moieties, the diffusion coefficients of the tags, the presence or absence of sieving matrices, nature of the electrophoretic apparatus, e.g. presence or absence of channels, length of separation channels, and the like. As used herein, “electropherogram data” means a table, or discrete function, F(Xᵢ) of signal intensity values for each migration time, Xᵢ, collected in the electrophoretic separation of molecular tags. Preferably, electropherogram data comprises fluorescence intensity values collected by conventional detection systems in a capillary electrophoresis instrument.

The term “sample” in the present specification and claims is used in a broad sense. On the one hand it is meant to include a specimen or culture (e.g., microbiological cultures), or both biological and environmental samples used as inputs to an assay. A sample may include a specimen of synthetic origin. Biological samples may be animal, including human, fluid, solid (e.g., stool) or tissue, as well as liquid and solid food and feed products and ingredients such as dairy items, vegetables, meat and meat by-products, and waste. Biological samples may include materials taken from a patient including, but not limited to cultures, blood, saliva, cerebral spinal fluid, pleural fluid, milk, lymph, sputum, semen, needle aspirates, and the like. Biological samples may be obtained from all of the various families of domestic animals, as well as feral or wild animals, including, but not limited to, such animals as ungulates, bear, fish, rodents, etc. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention. On the other hand, “sample” is also meant to refer to a volume of solution analyzed by electrophoresis. Thus, this volume of solution is placed into a “sample reservoir” associated with the electrophoretic system and components of the “sample” are separated.

A “sieving matrix” or “sieving medium” means an electrophoresis medium that contains crosslinked or non-crosslinked polymers, which are effective to retard electrophoretic migration of charged species through the matrix, wherein such retarding effect depends at least in part on the molecular shape of the migrating species. Sieving media are disclosed in Zhu et al, U.S. Pat. No. 5,089,111; Grossman et al, U.S. Pat. No. 5,126,021; Madabhushi et al, U.S. Pat. Nos. 5,552,028 and 5.567,292; Shihabi, Chapter 15, in Landers, editor, Handbook of Capillary Electrophoresis, Second Edition (CRC Press, Boca Raton, Fla.); and like references.

“Specific” or “specificity” in reference to the binding of one molecule to another molecule, such as a binding compound, or probe, for a target analyte, means the recognition, contact, and formation of a stable complex between the probe and target, together with substantially less recognition, contact, or complex formation of the probe with other molecules. In one aspect, “specific” in reference to the binding of a first molecule to a second molecule means that to the extent the first molecule recognizes and forms a complex with another molecules in a reaction or sample, it forms the largest number of the complexes with the second molecule. In one aspect, this largest number is at least fifty percent of all such complexes form by the first molecule. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak noncovalent chemical interactions, such as Van der Waal forces, hydrogen bonding, ionic and hydrophobic interactions, and the like, dominate the interaction of the molecules. As used herein, “stable complex” in reference to two or more molecules means that such molecules form noncovalently linked aggregates, e.g. by specific binding, that under assay conditions are thermodynamically more favorable than a non-aggregated state.

As used herein, the term “spectrally resolvable” in reference to a plurality of fluorescent labels means that the fluorescent emission bands of the labels are sufficiently distinct, i.e. sufficiently non-overlapping, that molecular tags to which the respective labels are attached can be distinguished on the basis of the fluorescent signal generated by the respective labels by standard photodetection systems, e.g. employing a system of band pass filters and photomultiplier tubes, or the like, as exemplified by the systems described in U.S. Pat. Nos. 4,230,558; 4,811,218, or the like, or in Wheeless et al, pgs. 21-76, in Flow Cytometry: Instrumentation and Data Analysis (Academic Press, New York, 1985).

“Time”, when used in relation to an electropherogram, is used synonymously with “separation time” meaning the time elapsed since the initiation of the electrophoretic separation process. The “migration time” typically refers to the time point at which a species appears in an electropherogram. For example, “molecular tag A has a migration time of 10.20 minutes” indicates there is a signal peak in the electropherogram at a separation time of 10.20 minutes that is due to molecular tag A.

### DETAILED DESCRIPTION OF THE INVENTION

The invention provides systems, methods and computer-readable products for analyzing one or more compounds by their electrophoretic properties. In one aspect, such analysis is carried out by identifying and determining the properties of one or more peaks in an electropherogram that describes signal intensity versus cumulative current, or cumulative power, over the course of a separation. The term “cumulative current” is used synonymously with “integrated current” or “accumulated charge”, and the term “cumulative power” is used synonymously with “integrated power” or “accumulated power”. Properties of a peak in an electropherogram include measures of peak area, peak shape, ordinate of the peak's maximum (referred to herein as the peak “position” or “migration time”), peak position relative to that of one or more standards (“relative migration time”), and the like.

The invention operates to correct for fluctuations in current or power that occur during the normal course of performing electrophoretic separations and that affect the electropherogram data. Electropherogram data are transformed from signal versus time to a new coordinate space of signal versus cumulative current or power to account for the fluctuations that occur in current or power during the separation. The use of current or power for the transformation is determined by the mode of the separation. For a constant voltage separation, use of the current data is sufficient for the analysis, whereas when the voltage and current vary, the power data is used. Electropherograms thus transformed are used for identifying and determining the properties of the peaks, and further, the compounds, or equivalently, the analytes, of the sample.

In one aspect the invention provides a method of identifying one or more analytes in a sample using electrophoretic separation comprising the following steps: (i) applying a potential across a separation path containing one or more analytes to generate a current and a power therein and to separate the one or more analytes so that a first electropherogram of a signal as a function of time is produced; (ii) integrating the power with respect to time to provide a cumulative power as a function of time; (iii) transforming the first electropherogram to a second electropherogram of the signal as function of the cumulative power; and (iv) identifying in the second electropherogram peaks that are correlated with the one or more analytes in the sample. The potential across a separation path may be constant or it may vary with time. In one embodiment, the potential across a separation path may be varied with time so that current in the path or the power in the path is constant. In another aspect, the method further comprises the steps of recording the current as a function of time, recording the potential as a function of time, and determining the power as a function of time from the recorded current and voltage. Preferably, a separation path comprises a capillary tube. During separation of analytes in accordance with the method of the invention, preferably at least one electrophoretic mobility standard is provided in the sample, wherein such standard is used to identify peaks that are correlated with the one or more analytes of said sample. More preferably, two mobility standards are provided wherein the mobility of the first electrophoretic standard is greater than that of any analyte and the mobility of the second electrophoretic standard is less than that of any analyte in said sample.

In one application of the above method, the one or more analytes of said sample are molecular tags, described more fully below, wherein each tag has a different electrophoretic mobility. Preferably, such molecular tags are generated in the sample as the result of a specific recognition event with at least one type of biomolecule selected from the group of proteins, antigens, receptors, DNA and RNA. Usually, the number of molecular tags in such an embodiment is a plurality in the range of from between 2 and 50.

In another aspect the invention provides a method of identifying one or more analytes in a plurality of samples using electrophoretic separation in the following steps: (i) applying a potential independently across each of a plurality of separation paths each containing one or more analytes to generate a current therein and to separate the one or more analytes in a sample associated therewith so that for each separation path a first electropherogram of a signal as a function of time is produced; (ii) integrating the current in each separation path with respect to time to provide for each separation path a cumulative current as a function of time; (iii) transforming each first electropherogram to a second electropherogram of the signal as function of the cumulative current for each separation path; and (iv) identifying in each second electropherogram peaks that are correlated with the one or more analytes in the sample associated therewith.

Another embodiment of this aspect of the invention is carried out in the following steps: (i) applying a potential jointly across a plurality of separation paths each containing one or more analytes to generate a current therein and to separate the one or more analytes in a sample associated therewith so that for each separation path a first electropherogram of a signal as a function of time is produced; (ii) integrating the current in each separation path with respect to time to provide for each separation path a cumulative current as a function of time; (iii) transforming each first electropherogram to a second electropherogram of the signal as a function of the cumulative current for each separation path; and (iv) identifying in each second electropherogram peaks that are correlated with the one or more analytes in the sample associated therewith. As with the aspect of the invention employing a single separation path, in both embodiments employing pluralities of separation paths, the potentials across the separation paths may be constant or may vary with time, one or more standards may be provided with samples to assist in the identification of analytes, and separation paths may comprise capillary tubes.

In another aspect of the invention, a method is provided for identifying one or more analytes in a sample using electrophoretic separation comprising the following steps: (i) applying a potential across a separation path to generate a current therein and to separate the one or more analytes in the sample, the separation path having a length, and each of the one or more analytes having an effective migration distance equal to or less than the length of the separation path; (ii) recording the current as a function of time in a series of consecutive segments along the length of the separation path, each such consecutive segments having a current; (iii) recording a time series of electropherograms of the signal intensity associated with the one or more analytes as a function of the migration distance; (iv) transforming at least one electropherogram to a second electropherogram of signal intensity as a function of effective migration distance, wherein the effective migration distance of an analyte is a function of the current in each of the consecutive segments of a separation path; and (v) identifying in such second electropherogram peaks that are correlated with the one or more analytes in the sample.

In still another aspect of the invention, a method is provided for identifying one or more analytes in a sample separated by electrophoresis to give a first data set of a signal as a function of time and a data set of the separation path power as a function of time, the method comprising the steps of: (i) integrating the separation path power data set with respect to time to provide a cumulative power as a function of time; (ii) transforming the first signal data set to a second data set of the signal as a function of the cumulative power; and (iii) identifying in the second data set peaks that are correlated with the one or more analytes in the sample.

In a further aspect of the invention, a method is provided for identifying one or more analytes in a sample separated by electrophoresis to give a first data set of a signal as a function of time and a data set of the separation path current as a function of time, the method comprising the steps of: (i) integrating the separation path current data set with respect to time to provide a cumulative current as a function of time; (ii) transforming the first signal data set to a second data set of the signal as a function of the cumulative current; and (iii) identifying in the second data set peaks that are correlated with the one or more analytes in the sample.

As described more fully below, aspects of the invention may be implemented using a computer operating under the control of software instructions recorded on a computer-readable product. Accordingly, an aspect of the invention is a computer-readable product embodying a program for execution by a computer to identify one or more analytes in an electrophoretic separation by determining peak locations in a transformed electropherogram and correlating such peak locations with each of the one or more analytes, the program comprising instructions for carrying out the following steps: (i) reading a first electropherogram data set based on an analyte signal as a function of separation time from a data storage medium; (ii) reading a data set of power as a function of separation time from a data storage medium; (iii) determining a data set of cumulative power as a function of separation time; (iv) transforming the first electropherogram data set to a second electropherogram data set of the analyte signal as a function of the cumulative power; (v) identifying peak locations in the second electropherogram; and (vi) correlating the identified peak locations with each of the one or more analytes. Preferably, the step of reading a data set of power as a function of separation time comprises: (i) reading a data set of current as a function of separation time from a data storage medium; (ii) reading a data set of potential as a function of separation time from a data storage medium; and (iii) determining using the current and the potential data sets, a data set of power as a function of separation time.

### Methods and Instrumentation for Electrophoretic Separation

Methods for electrophoresis of are well known and there is abundant guidance for one of ordinary skill in the art to make design choices for forming and separating particular pluralities of compounds. The following are exemplary references on electrophoresis: Krylov et al, Anal. Chem., 72: 111R-128R (2000); P. D. Grossman and J. C. Colbum, Capillary Electrophoresis: Theory and Practice, Academic Press, Inc., NY (1992); U.S. Pat. Nos. 5,374,527; 5,624,800; 5,552,028; ABI PRISM 377 DNA Sequencer User's Manual, Rev. A, January 1995, Chapter 2 (Applied Biosystems, Foster City, Calif.); and the like. In one aspect, one or more analytes are separated by capillary electrophoresis and the resulting electropherogram transformed for analysis. Design choices within the purview of those of ordinary skill include but are not limited to selection of instrumentation from several commercially available models, selection of operating conditions including separation media type and concentration, pH, desired separation time, temperature, voltage, capillary type and dimensions, detection mode, the number of analytes to be separated, and the like.

In one aspect of the invention, during or after electrophoretic separation, the analytes are detected or identified by recording fluorescence signals and migration times (or migration distances) of the separated compounds, or by constructing a chart of relative fluorescence as a function of time or order of migration of the analytes (e.g., as an electropherogram). To perform such detection, the analytes can be illuminated by standard means, e.g. a high intensity mercury vapor lamp, a laser, or the like. Typically, the analytes are illuminated by laser light generated by a He—Ne gas laser or a solid-state diode laser. The fluorescence signals can then be detected by a light-sensitive detector, e.g., a photomultiplier tube, a charged-coupled device, or the like. Exemplary electrophoresis detection systems are described elsewhere, e.g., U.S. Pat. Nos. 5,543,026; 5,274,240; 4,879,012; 5,091,652; 6,142,162; or the like. In another aspect, analytes may be detected electrochemically detected, e.g. as described in U.S. Pat. No. 6,045,676.

Electrophoretic separation involves the migration and separation of molecules in an electric field based on differences in mobility. Various forms of electrophoretic separation include, by way of example and not limitation, free zone electrophoresis, gel electrophoresis, isoelectric focusing, isotachophoresis, capillary electrochromatography, and micellar electrokinetic chromatography. Capillary electrophoresis involves electroseparation, preferably by electrokinetic flow, including electrophoretic, dielectrophoretic and/or electroosmotic flow, conducted in a tube or channel of from about 1 to about 200 micrometers, usually, from about 10 to about 100 micrometers cross-sectional dimensions. The capillary may be a long independent capillary tube or a channel in a wafer or film comprised of silicon, quartz, glass or plastic.

In capillary electroseparation, an aliquot of the reaction mixture containing the analytes is subjected to electroseparation by introducing the aliquot into an electroseparation channel that may be part of, or linked to, a capillary device in which an assay, an amplification reaction or other reactions are performed. An electric potential is then applied to the electrically conductive medium contained within the channel to cause migration of the components within the combination. Generally, the electric potential applied is sufficient to achieve electroseparation of the desired components according to practices well known in the art. One skilled in the art will be capable of determining the suitable electric potentials for a given set of reagents, compounds or analytes and/or the nature of the samples, the nature of the reaction medium and so forth. The parameters for the electroseparation including those for the medium and the electric potential are usually optimized to achieve maximum separation of the desired components. This may be achieved empirically and is well within the purview of the skilled artisan.

Detection may be by any of the known methods associated with the analysis of capillary electrophoresis columns including the methods shown in U.S. Pat. Nos. 5,560,811 (column 11, lines 19-30), 4,675,300, 4,274,240 and 5,324,401, the relevant disclosures of which are incorporated herein by reference. Those skilled in the electrophoresis arts will recognize a wide range of electric potentials or field strengths may be used, for example, fields of 10 to 1000 V/cm are used with about 200 to about 600 V/cm being more typical. The upper voltage limit for commercial systems is about 30 kV, with a capillary length of about 40 to about 60 cm, giving a maximum field of about 600 V/cm. For DNA, typically the capillary is coated to reduce electroosmotic flow, and the injection end of the capillary is maintained at a negative potential.

For ease of detection, the entire apparatus may be fabricated from a plastic material that is optically transparent, which generally allows light of wavelengths ranging from about 180 to about 1500 nm, usually about 220 to about 800 nm, more usually about 450 to about 700 nm, to have low transmission losses. Suitable materials include fused silica, plastics, quartz, glass, and so forth.

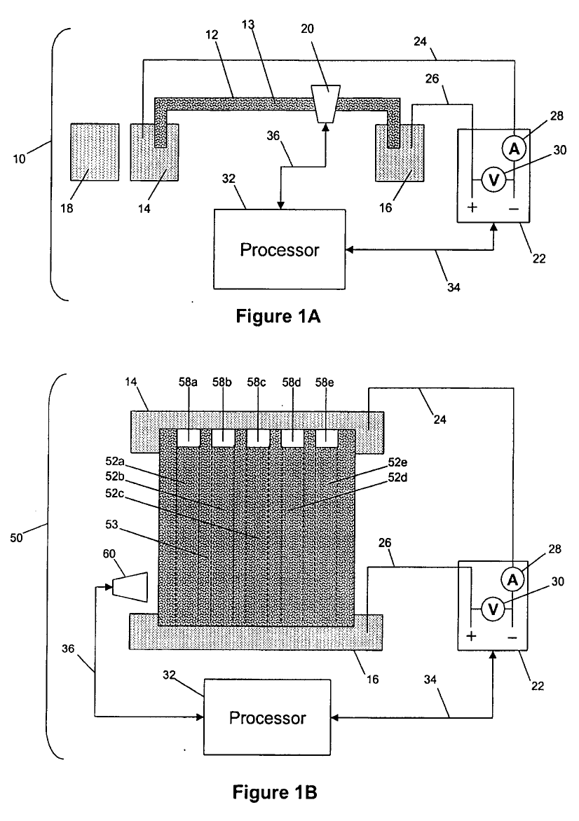

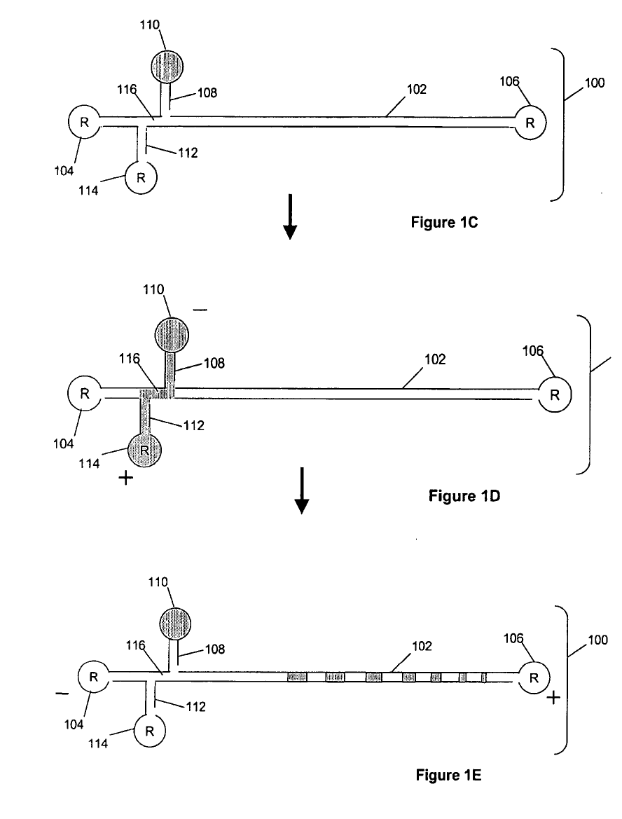

FIG. 1A is a schematic illustration of an exemplary capillary electrophoresis system 10 for performing the method of the present invention. In the figure, the separation path is capillary tube 12 containing separation medium 13, and which spans between a cathodic reservoir 14 and an anodic reservoir 16, both of which contain a conducting electrolyte medium. Generally, a “separation path” is a geometrically-defined route within which the separation medium is confined and along which a potential gradient is established. Depending on the type of electrophoresis instrument or equipment, a separation path is variously referred to as a “channel”, “capillary”, or “lane”, the latter being the common nomenclature for conventional molecular biology slab gels. A sample reservoir 18 and reservoir 14 are interchangeably contacted with capillary tube 12 to provide for introduction of the sample, which may be accomplished electrokinetically or pneumatically. The relationship between the anodic and cathodic reservoirs in FIG. 1A may be reversed, according to the nature of the analytes being analyzed. As illustrated here, the setup is appropriate for the analysis of anionic analytes, which are drawn into the capillary tube 12 containing separation medium 13 and past detector 20, towards the anodic reservoir 16. Power supply 22 applies a potential across the separation path via the cathodic 24 and anodic 26 electrodes that are contacted to reservoirs 14 and 16 so that a potential gradient, equivalently an electrical field, collinear with the separation path is established. The polarity of the connection of the electrodes to the reservoirs determines the direction of the potential gradient and the ion movement and thus whether anionic or cationic analytes are analyzed at detector 20. A current measuring device 28 and voltage measuring device 30 for measuring, respectively, the electrophoretic current in the separation path and the voltage, or equivalently, the potential across the separation path may also be associated with system 10.

The system 10 is operated under the control of computer processor 32. The processor 32 communicates with power supply 22, current measuring device 28 and voltage measuring device 30 via cable 34, and communicates with detector 20 via cable 36. The cables 34 and 36 may provide for one-way or two-way communication. In the former case of one way communication, the data measured by devices 28 and 30, and detector 20 are typically transferred to the processor wherein the data may be manipulated, stored, displayed, further transmitted to another computer or likewise treated as data sets. Where the cables act as a two-way data bus, signals for powering, controlling, adjusting or otherwise tuning the voltage, current and power of the electrophoretic separation and the detector function may be sent from the processor 32 to the various components. The power supply 22 itself may also function to control and adjust the power, voltage and current applied during the electrophoretic separation. For example, power supplies that operate in constant voltage, constant current, or constant power modes are available.

As noted, several manufacturers have available automated instruments for capillary electrophoresis that may be used in accordance with the invention. Some instruments provide only one capillary tube, while others contain a bundled array of tubes, varying from 4 to 16 to 96 or even 256 tubes, for what is referred to as capillary array electrophoresis.

The operation is exemplified with a sample that is a particular assay mixture, although it should be understood that any sample type or mixture of compounds that is used in the art of electrophoretic separations is within the intended scope of the invention. The assay mixture, which as noted below contains one or more targets, one or more tagged protein or DNA probes, and optionally, at least one electrophoretic standard, is placed in sample reservoir 18. The assay reaction, involving initial probe binding to target(s) followed by the release of molecular tags, which in this example are the analytes, may be carried out in sample reservoir 18, or alternatively, the assay reactions can be carried out in another reaction vessel, with the reacted sample components then added to the sample reservoir.

The sample reservoir 18 is brought into contact with capillary tube 12 and the sample is injected into the separation medium 13 in the tube either by application of a potential or pressure. Once injected, the tube 12 is contacted with reservoir 14, the power supply 22 applies a voltage via electrodes 24 and 26 to the reservoirs 14 and 16 to cause the formation of a potential gradient along the separation path 12 and thus the migration of charged components of the sample through the separation medium 13. As analytes move past detector 20, a signal indicating their presence and amount is recorded as a function of the time by processor 32 to form a first electropherogram. Also during the separation the current or the power in the separation path is recorded as a function of time. As disclosed more fully below, the current or power data set is integrated to provide the cumulative current or power, the first electropherogram is transformed to a second electropherogram of signal as a function of the cumulative current or power, and the peaks are identified by correlation to the analytes in the sample.

FIG. 1B is a schematic illustration of a slab gel electrophoresis system 50 useful for performing the invention, wherein like-numbered components with FIG. 1A perform the same function as described above. The slab gel comprises separation paths 52a-52e comprising separation medium 53. Although the separation paths in a gel are in fluidic and electrical communication with one another, the migrating samples move substantially in a direct line along the potential gradient and remain substantially isolated from one another, and thus each sample is said to be confined with a lane. The slab gel may be a free-standing gel such as is commonly performed in the art for agarose gels, or the gel may be supported between two, narrowly spaced plates such as is known in the art for polyacrylamide gels. Slab gels are variously oriented horizontally or vertically, depending on the type of gel and separation being performed. See, for example, U.S. Pat. Nos. 4,830,725 and 4,773,984, respectively, for examples of each gel type.

Generally, wells 58a-58e are preformed in the separation medium and are the means by which samples are introduced to the separation medium in each lane 52a-52e. For illustrative purposes only a limited number of wells and separation paths 52a-52e are depicted, however the number of wells, the width and the spacing of the wells will be varied according to the number of samples, desired throughput, scale, resolution, power supply capability and the like as is commonly known in the art. It is appreciated that in slab gels, the separation paths for each sample are not isolated from one another as is the case for capillary tube arrays, but rather these separation paths are in fluid and electrical communication. Nonetheless, as is known by those skilled in the art, the samples are maintained within distinct lanes and the detection process generates distinct electropherograms.

The detector 60 measures the signal associated with the analytes as function of the separation time in each lane. The detector 60 may be responsive to any of the typical signals used in conjunction with gel electrophoresis, especially the emitted visible or infrared light produced by fluorophores. For convenience the detector may only respond to a small area, i.e. one lane or a fraction thereof, and be periodically scanned across all the lanes in order to measure the signal for each lane, e.g. as disclosed by Hunkapiller et al. in U.S. Pat. No. 4,811,218.

In operation, samples are transferred to the sample reservoirs 58a-e. A power supply 22 applies a voltage via electrodes 24 and 26 to the reservoirs 14 and 16 to establish a potential gradient along the separation paths 52a-52e in the gel, and thus cause electrophoretic migration of the charged components of the sample through the separation medium 53. Detector 20 monitors a signal indicating the presence and the amount of each analyte in each separation path, which is recorded by processor 32 to form a first electropherogram for each separation path. Also during the separation the current or the power in the separation paths is recorded as a function of time. As disclosed more fully below, the current or power data set is integrated to provide the cumulative current or power, the first electropherograms are transformed to second electropherograms of signal as a function of the cumulative current or power, and the peaks are identified by correlation to the analytes in the samples.

In another aspect of the invention, the electrophoretic separation is carried out in a microfluidics device, as illustrated diagrammatically in FIGS. 1C-1E. Microfluidics devices are described in a number of domestic and foreign Letters Patent and published patent applications. See, for example, U.S. Pat. Nos. 5,750,015; 5,900,130; 6,007,690; and WO 98/45693; WO 99/19717 and WO 99/15876. Conveniently, an aliquot, generally not more than about 5 μL, is transferred to the sample reservoir of a microfluidics device, either directly through electrophoretic or pneumatic injection into an integrated system or by syringe, capillary or the like. The conditions under which the separation is performed are conventional and will vary with the nature of the products.

By way of illustration, FIGS. 1C-1E show a microchannel network 100 in a microfluidics device of the type detailed in the application noted above, for sample loading and electrophoretic separation of a sample of probes and tags produced in the assay above. Briefly, the network includes a main separation channel 102 terminating at upstream and downstream reservoirs 104, 106, respectively. The main channel is intersected at offset axial positions by a first side channel 108 that terminates at a reservoir 110, and a second side channel 112 that terminates at a reservoir 114. The offset between the two side channels forms a sample-loading zone 116 within the main channel.

In operation, a sample or an assay mixture is placed in sample reservoir 110, illustrated in FIG. 1C. Assay reactions may be carried out in sample reservoir 110, or alternatively, the assay reactions can be carried out in another reaction vessel, with the reacted sample components then added to the sample reservoir.

To load the analytes into the sample-loading zone, an electric field is applied across reservoirs 110, 114, in the direction indicated in FIG. 1D, wherein negatively charged analytes are drawn from reservoir 110 into loading zone 116, while uncharged or positively charged sample components remain in the sample reservoir. The analytes in the loading zone can now be separated by conventional capillary electrophoresis, by applying an electric filed across reservoirs 104, 106, in the direction indicated in FIG. 1E.

As analytes move past a detector, a signal indicating their presence and amount is recorded as a function of the time by a processor to form a first electropherogram. Also during the separation the current or the power in the separation path is recorded as a function of time. As disclosed more fully below, the current or power data set is integrated to provide the cumulative current or power, the first electropherogram is transformed to a second electropherogram of signal as a function of the cumulative current or power, and the peaks are identified by correlation to the analytes in the sample.

Other operating methods and designs for microfluidics CE devices are known in the art, such as described in U.S. Pat. Nos. 5,858,195; 6,001,229, 6,010,607, 6,110,332; 6,143,152; or the commercially available Bioanalyzer 2100 (Agilent Technologies, Santa Clara, Calif.), may also be used in conjunction with the present invention without limitation.

### Measuring Current, Voltage and Power

As mentioned above, an object of the invention is to provide improved analyte identification by correcting for fluctuations in current or power within separation paths in an electrophoretic separation. The mobility (v) of a charged species in an electric field is given by the equation:
v=(qE)/πrη
where q is the charge of the species, E is the potential field strength (i.e. (V/d), the voltage applied (V) divided by the distance (d) over which it is applied), r is proportional to the size of the species and η is the viscosity of the separation medium (Physical Chemistry, P. W. Atkins and J. de Paula, 7^{th} ed., 2001). When applied in the context of electrophoresis, the mobility can be used to determine an expected migration time of the charged species along a separation path from e.g., the inlet to the detector. However, this requires several assumptions be made, such as that the voltage applied during the separation and the viscosity of the separation medium, which is a strong function of the temperature, are constant. Electrophoresis instruments are generally designed and operated in a manner that controls or minimizes these variations, e.g. by operating at constant voltage and actively regulating the temperature, in order to provide consistent and reproducible performance.

In most cases though the design is not able to address all the causes of variation and differences in the data from run to run persist. For example, in instruments with multiple capillaries the potential gradient established in each capillary will differ to the extent that the capillaries differ in length. Thus, to minimize run-to-run variations, practitioners develop standard methods and adhere to standard protocols. However even in this environment, samples, especially those derived from biological sources, may have different compositions of ions and other charged species. Differences in the ionic content of samples will manifest itself in different behavior during sample injection into the capillary. Consequently, different sample plug injections will yield different local conditions in the separation path of the electrophoretic analysis.

Electrophoretic analysis generally consists of effecting a separation using constant voltage while recording the signal as a function of time (or distance). However, even if a constant voltage is maintained, the potential gradient in the separation path typically varies both from path to path, as well as along and within the length of each path, giving rise to non-uniform migratory trajectories and varying current profiles. Electrophoretic mobility standards are often used as a means to correct for run-to-run variations by analyzing the mobility of the analytes as a ratio with respect to the mobility of the standards. This provides a first-order correction in some cases, but there are still occasions in which the variation in the separation performance is non-linear.

The information provided by the current or the power in the separation path as a function of the separation time is employed in the present invention to further incorporate the conditions present during the separation into the information content of the electropherogram. By measuring the current and voltage present in the separation path, the current or power profile during the separation can be used to correct the electropherogram graph. In cases where the separation is performed at constant voltage, monitoring and recording the current provides sufficient information regarding the variation during the run. Conversely, if the separation is run at constant current, then monitoring and recording the voltage provides the necessary information regarding the variation during the run. In some cases neither the voltage nor current is strictly regulated, in which case both parameters are monitored and recorded in order that the power as a function of time is known. Power meters may be also be used to monitor and record the power, although fundamentally the measuring device operates by determining separately the current and the voltage. In some protocols, a series of different constant voltage or constant current conditions are established in the separation path. In yet some other protocols, a known, varying profile of voltage or current is established in the separation path. In these other protocols there is the need to monitor and record both the voltage and current as a function of time in order to know the power profile during the separation.

Current in a circuit is measured by an ammeter, which is typically constructed of a circuit comprising a shunt resistor. The voltage difference between two points in a circuit is measured by a voltmeter, which is typically constructed of a circuit comprising a series resistor. Digital ammeters and digital voltammeters that also provide autoscaling and data logging capability are commercially available (from e.g. Fluke Corporation, Everett, Wash., or Agilent Technologies, Santa Clara, Calif.). Furthermore the circuit designs of ammeters and voltammeters are well known to those skilled in the electronic arts. Power in a circuit a product of the current multiplied by the voltage. The power may be measured by a wattmeter, or a dynamometer. More typically, the current and voltage are measured separately and multiplied together. The measurements and recorded data sets may be analog in format, but for ease of further manipulation, calculation and storage, data in a digital format are preferred.

Current, voltage and power measurement capability are often provided in power supply instruments. Furthermore, automated electrophoresis instruments also generally comprise current and voltage measurement capabilities. For example, the MegaBACE 1000 capillary array electrophoresis instrument (Amersham Biosciences, Piscataway, N.J.) provides records of current and voltage measurements for each capillary, and the ABI 3100 (Applied Biosystems, Foster City, Calif.) provides records of current and voltage measurements for the collective array of capillaries.

In the present invention the current, voltage or power is measured periodically during the separation process in order to provide a data set of the measurement as a function of the separation time. The choice of the parameters of current, voltage or power that are to be measured is discussed in more detail below. The measurements are used to provide a data set of the current, voltage or power at time points corresponding to the time points of the signal measurement provided by the detector. It is noted that the frequency of the signal measurement is set according to the requirements of forming an electropherogram with sufficient resolution of the peaks.

Preferably, the frequency of measurement of current, voltage or power is approximately the same as the sampling rate of the detector in recording the signal associated with the analytes, although the frequency may be higher. If the frequency of the current, voltage or power measurement is less than half the frequency of the detector measurement (i.e. the measurement is made once in a period of two or more detector readings), interpolation of the current, voltage or power data may be used to generate data values corresponding to the time point of each detector reading. Likewise if the value of the time points for the current, voltage or power measurements are different from those of the signal data set, again interpolation may be used to generate data values at the corresponding time points. Either the signal data set or the current, voltage or power data sets may be interpolated to provide data at time points corresponding to those of the other group.

### Electrophoretic Analysis with Transformed Electropherograms

The invention provides a means for identifying analytes in a sample by electrophoresis, particularly for transforming the obtained electropherogram, i.e. a first electropherogram, to a representation of the signal as a function of the electrical parameters of the separation process, whereupon the transformed electropherogram, i.e. a second electropherogram, is used as the basis for peak identification and correlation with the expected migration time of the analytes.

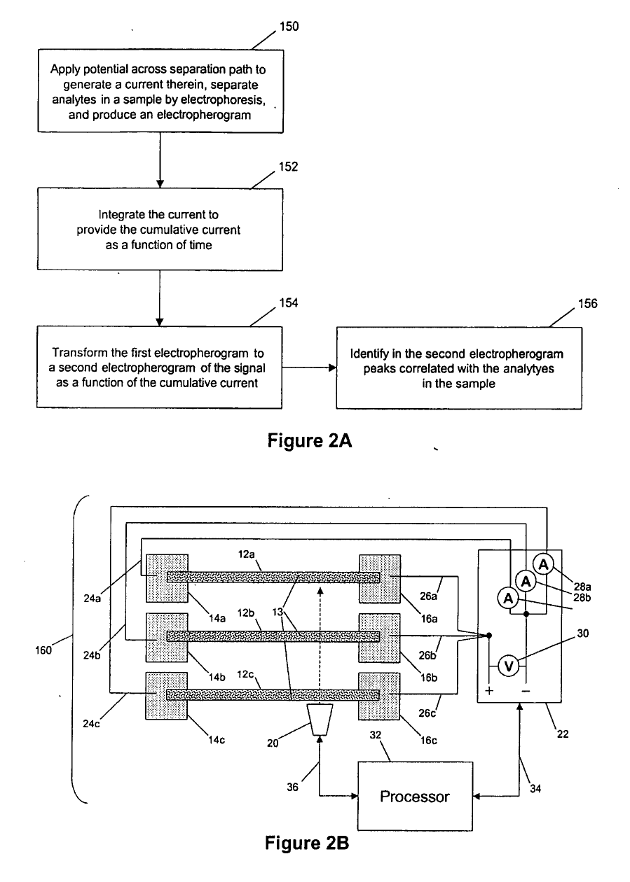

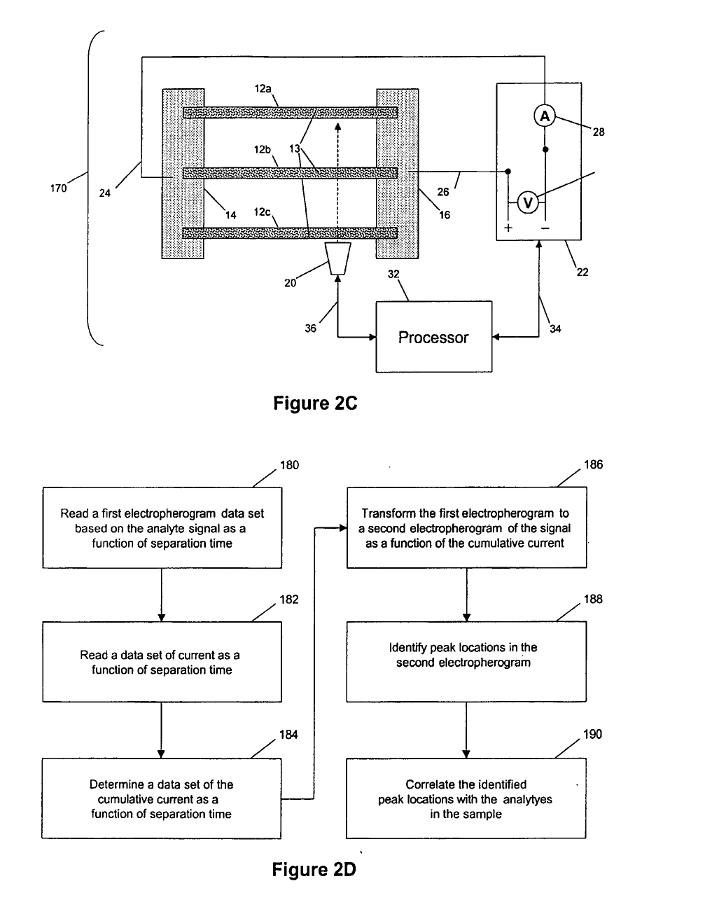

Referring to FIG. 2A, the steps, according to one embodiment of the present invention, of a method for identifying one or more analytes in a sample by electrophoresis are enumerated. The method comprises first applying a potential across a separation path (150) to generate a current therein and to separate the one or more analytes in the sample by electrophoresis to produce an electropherogram of a signal as a function of time. Suitable electrophoresis systems are exemplified in FIGS. 1A-1E. In a preferred embodiment, the potential applied across the separation path is constant, using for example a constant voltage power supply.

The next step is integrating the current with respect to time (152) to provide the cumulative current as a function of time. As noted, it is preferred that the data be in a digital format, i.e. that data sets are series of discrete values. Thus, the preferred integration method uses numerical analysis. Examples of numerical analytical integration methods are described in Numerical Computation 2: Methods, Software and Analysis, by C. W. Ueberhuber (Springer-Verlag, 1997). One preferred method of integration to determine the cumulative current up to each time point is the following summation:

$${I}_{c} ( t ) = {I}_{0} + {\sum }_{i = 1}^{t} {I}_{i} ; for each t , from t = 1 to t = T$$

where I_{c} is the cumulative current, t is each sampled time point, I₀ is the current at t=0, Iᵢ is the current sampled at the i^{th} time point, and T is the total separation time, to generate a data set of the series of I_{c} as a function of time.

The next step is transforming the electropherogram to a second electropherogram (154) of the signal as a function of the cumulative current. The method of the invention calls for mapping the electropherogram to a new coordinate system based on the electrical characteristics, the current or the power, of the separation. The two measured quantities, the signal and the cumulative current, are explicit functions of an independent variable, time. This relationship defines parametric equations. The transformation is carried out by forming ordered pairs of values of the signal and cumulative current for each time point in the separation. Thus, the second electropherogram represents the signal as a function of the cumulative current and may be graphed and analyzed in manner analogous to signal versus time plots.

The final step in the method is identifying (156) in the second electropherogram peaks that are correlated with the one or more analytes in the sample. Using the transformed, or second, electropherogram as the basis for the analysis, the procedure for peak identification is fully described in a following section.

In another embodiment, the potential applied across the separation path varies with time. In this case, the current is no longer sufficient for the transformation, and the potential must also be used. An appropriate integration method is the following summation:

$$V \cdot {I}_{c} ( t ) = {V}_{0} \cdot {I}_{0} + {\sum }_{i = 1}^{t} {V}_{i} \cdot {I}_{i} ; for each t , from t = 1 to t = T$$

where V·I_{c} is the cumulative voltage·current product, t is each sampled time point, V₀ is the potential and I₀ is the current at t=0, V, is the potential and Iᵢ is the current sampled at the i^{th} time point, and T is the total separation time, to generate a data set of the series of V·I_{c} as a function of time. In this embodiment the first electropherogram is transformed to a second electropherogram of the signal as a function of the current and potential.

In another embodiment, the method comprises applying a potential across a separation path to generate a current and a power therein, and then integrating the power with respect to time to provide the cumulative power as a function of time. Here, the appropriate integration method is:

$${P}_{c} ( t ) = {P}_{0} + {\sum }_{i = 1}^{t} {P}_{i} ; for each t , from t = 1 to t = T$$

where P_{c} is the cumulative power, t is each sampled time point, P₀ is the power at t=0, Pᵢ is the power sampled at the i^{th} time point, and T is the total separation time, to generate a data set of the series of P_{c} as a function of time. In preferred embodiments the power is obtained as the product of the current multiplied by the potential, which are each known by independent measurement, and thus the appropriate terms in the summation are explicitly given in the previous equation. The transformation is then carried out by forming ordered pairs of values of the signal and cumulative power for each time point.

In yet another embodiment, the invention provides a method of identifying one or more analytes in a sample separated by electrophoresis to give a first data set of a signal as a function of time and a data set of the separation path current as a function of time. The method comprises integrating the separation path current data set to provide a cumulative current as a function of time, the preferred method of integration being numerical analysis techniques. The next step is transforming the first signal data set to a second data set of the signal as a function of the cumulative current, as described earlier via the parametric relationship, and then identifying in the second data set peaks that are correlated with the one or more analytes in the sample.

Another aspect of the present invention is a method of identifying one or more molecular tags in a sample using electrophoretic separation. At least one electrophoretic mobility standard is added to the sample prior to separation. Preferably, two mobility standards are added, more preferably wherein one has a greater mobility and the other has a lesser mobility than that of any analyte in the sample. The molecular tags are present in the electrophoresis sample as result of an assay for biomolecules, such as proteins, antigens, antibodies, receptors, or nucleic acids (DNA, RNA and the like) in a biological sample, examples of which are further described below. Provided such a sample of molecular tags, preferably a plurality of tags which may number from 2 to 20 or even as many as 50, the above described methods are followed to achieve the identifying of the analytes.

In some methods of electrophoresis, the result of the separation is analyzed on the basis of the migration distance, that is, the distance that each analyte has migrated during the separation. Where local variations in the separation conditions have affected the local mobility of the analytes differentially, the present invention contemplates methods for correcting for these fluctuations and differential perturbations.

The first step of a method for identifying analytes in an electrophoretic separation using migration distance is applying a potential across the length of a separation path to generate a current therein and to separate the one or more analytes in each sample by electrophoresis. During the separation, the current is recorded as a function of time in a series of consecutive segments of the separation path. The separation path is divided into segments and each segment is provided with means for measuring and recording the current in that segment as a function of time. For example, a series of electrodes fabricated on the surface defining the separation path can define the series of segments. The electrodes are used as probes, and, with the use of external circuitry such as is used in digital multimeters for the diagnosis of electronic circuits, provide measurements of the resistivity, potential difference and current between any two electrodes defining a segment.

The method also calls for recording a time series of electropherograms of the signal intensity associated with the analyte as a function of the migration distance. The time series of electropherograms are recorded at about the same frequency as the current measurements in each segment. The data sets of the current as a function of location and the signal vs. distance are the basis for transforming at least one electropherogram to represent the signal intensity as a function of the effective migration distance, wherein the effective migration distance is a function of the current experienced by each peak in each separation path segment. Finally, the transformed electropherogram is used to identify in the at least one electropherogram peaks that are correlated with the one or more analytes in the sample.

The invention also provides systems for carrying out the above methods. It is contemplated that in addition to the single channel capillary electrophoresis apparatus exemplified in FIG. 1A, multichannel CE instruments may also be used. Two such systems are illustrated in FIGS. 2B and 2C, where for purposes of clarity three-channel CE systems are shown. As noted, there are several types of capillary array electrophoresis instruments that have from 4 to 256 capillaries, as well as planar CE devices that accommodate e.g. 12 samples. Comparing FIGS. 2B and 2C with FIG. 1A, like-numbered components perform the same function and operation as described previously. In a multichannel system there are design choices to be made in the construction of an instrument. FIG. 2B illustrates a system 160 with independent capillaries. The same potential is applied in parallel by power supply 22 across each of the three separation paths 12a-c, but the current generated in each path is independent of the others. Thus the current or power may be separately monitored and recorded for each path, for example by current measuring devices 28a-c. The signal associated with the analytes in each separation path is measured by detector 20. In this manner, the analysis and identification of the analytes in each sample may be performed in the same manner as described above since the same information is independently available for each sample. Reservoirs 16a-c may be combined to be in fluid communication without loss of function in the illustrated scenario of FIG. 2B.

In FIG. 2C, a system 170 with the several capillaries terminating at each end in common reservoirs 14 and 16 is illustrated. The difference between this design and that of FIG. 2B is that though the potential may applied in parallel across all the separation paths 12a-c, the current or power can no longer be independently measured for each separation path. This situation also obtained in the slab gel electrophoresis system of FIG. 1B. In this case the current for each path is determined to be the prorated share of current for each separation path based on the known geometry, resistivity, temperature, and other physical characteristic of each path. In a preferred embodiment, the prorated share of current is determined solely by the relative geometric cross-section of each separation path. For example, in system 170, assuming the three capillary tubes 12a-c have identical cross-sectional areas, the prorated share of current in each path is the total current, as measured by ammeter 28, divided by three. In this manner, the analysis and identification of the analytes in each sample may be performed as previously described using the signal recorded by detector 20, the applied potential and the prorated current for each separation path.

In one embodiment of a system for performing the invention, the system comprises, with reference to FIG. 1A, a separation path 12, a voltage source 22 for applying a potential across the separation path 12 wherein a current is generated, a detector 20 positioned along the separation path 12 for recording a first electropherogram of the signal as a function of time, and a processor 32 comprising software for integrating the current to provide the cumulative current as a function of time, transforming the first electropherogram to a second electropherogram of the signal as a function of the cumulative current, and identifying in the second electropherogram peaks that are correlated with the analytes in the sample. In a preferred embodiment the voltage source applies a constant potential.

In another embodiment, the potential and current vary during the separation, in which case the power in the separation path is integrated, and the second electropherogram is a function of the cumulative power.

### Computer System and Programs

A computer preferably performs steps of transforming the electropherogram and the method of identifying peaks in electropherogram data described above. In one embodiment, a computer comprises a processing unit, memory, I/O device, and associated address/data bus structures for communicating information therebetween. The processing unit may be a conventional microprocessor driven by an appropriate operating system, including RISC and CISC processors, a dedicated microprocessor using embedded firmware, or a customized digital signal processing circuit (DSP), which is dedicated to the specific processing tasks of the method. The memory may be within the microprocessor, i.e. level 1 cache, fast S-RAM, i.e. level 2 cache, D-RAM, flash, or disk, either optical or magnetic. The I/O device may be any device capable of transmitting information between the computer and the user, e.g. a keyboard, mouse, network card, or the like. The address/data bus may be a PCI bus, NU bus, ISA, or any other like bus structure. When the computer performs the method of the invention, the above-described method steps are embodied in a program stored in or on a computer-readable product. Such computer-readable product may also include programs for graphical user interfaces and programs to change settings on electrophoresis systems or data collection devices.

The invention also provides a computer-readable product for identifying one or more analytes by determining peak locations in a transformed electropherogram and correlating the peaks with the analytes. In one embodiment, the product comprises the listed instructions of FIG. 2D. A first electropherogram data set of a signal as a function of separation time (180) and a data set of current as function of time (182) are read into memory. The current data set is integrated using numerical methods to provide a data set of the cumulative current as a function of time (184), which may also be stored in memory. As discussed above, in some cases a data set of power as a function of time is preferred over the data set of current. The first electropherogram is transformed as discussed above to a second electropherogram of the signal as a function of the cumulative current (186). In the second electropherogram, the peak locations are identified (188), as discussed in the following section, and the peak locations are correlated with the analytes.

Recognizing that in some cases peak identification and correlation with analytes are performed manually, or by visual inspection, another embodiment of the invention provides a computer-readable product for transforming electropherograms. In a manner similar to that described in conjunction with FIG. 2D, a first electropherogram data set of a signal as a function of time is read into memory, and a data set of either a current or power as a function of time is also read into memory. The data set of current or power is integrated using numerical methods to provide the cumulative current or power as a function of time. Finally the first electropherogram is transformed to a second electropherogram representing the signal as a function of the cumulative current or power, to provide a transformed electropherogram for further use or inspection.

### Peak Identification From Electropherogram Data

In the following discussion, the electropherograms are stated to be representing the signal as a function of time for convenience. In the present invention, the method of analysis involves transforming electropherograms from signal versus time to signal versus cumulative current or cumulative power to correct the data for variations in the separation conditions over time. These transformations may be regarded as mapping the electropherogram onto a function of modified time. Accordingly, in the following discussion the terms time, migration time, relative migration time and the like should be viewed as being related to the modified time, with the relationship between time and modified time being determined by the method used for transforming the first electropherogram to a second electropherogram.

Also in the following discussion, the analytes are exemplified as being “molecular tags”, however the discussion should be understood to be generally applicable to all types of analytes, compounds and species that are separated and analyzed in the arts of electrophoretic separations. It is commonly understood in the art that the methods of analysis of the results of a separation are independent of the particular composition of the sample being analyzed.

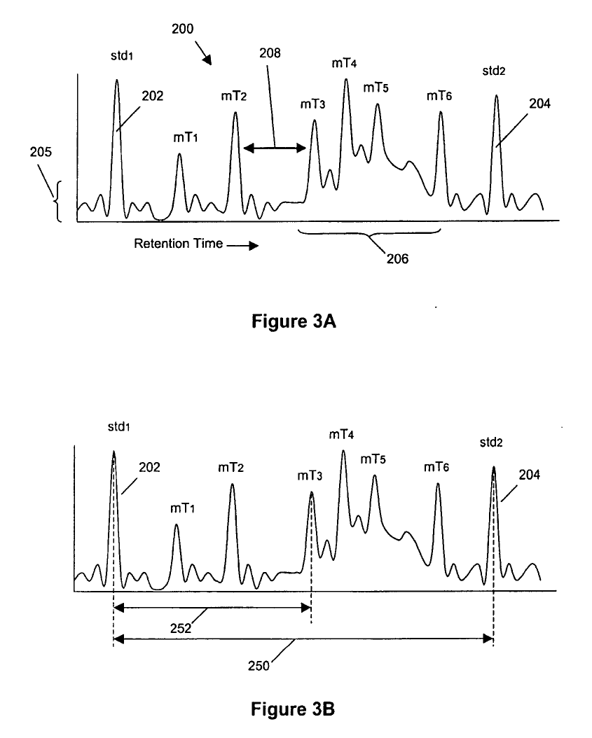

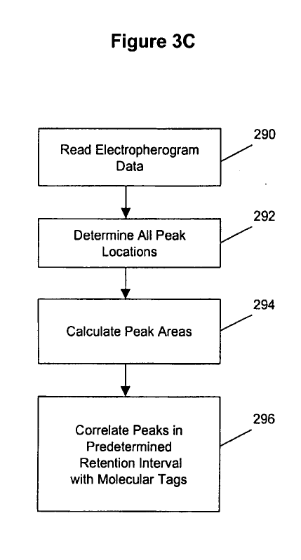

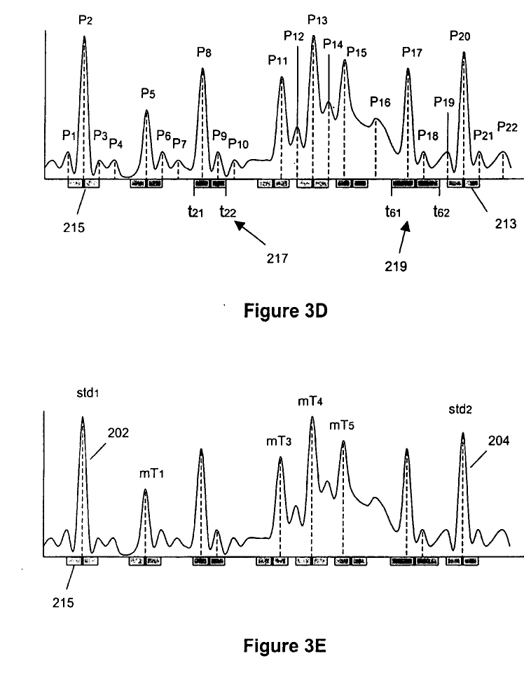

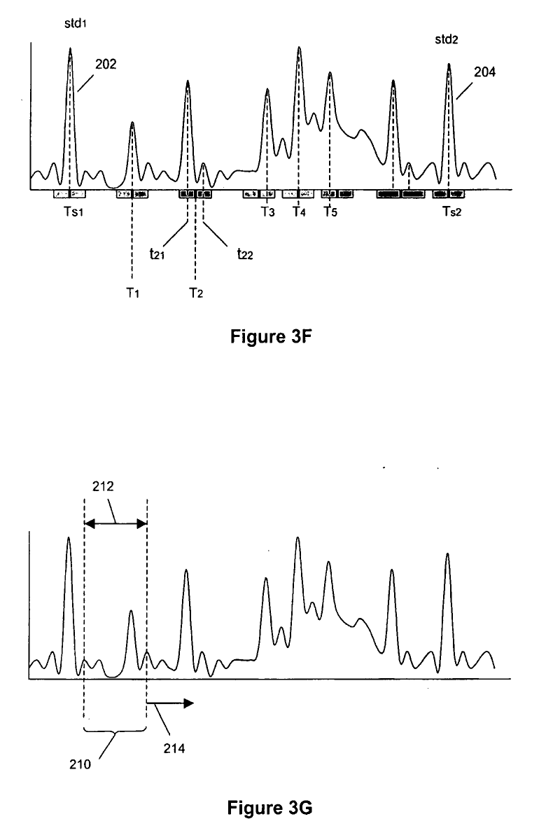

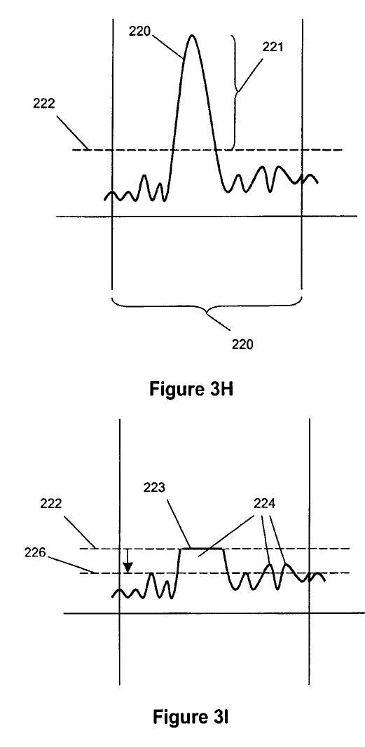

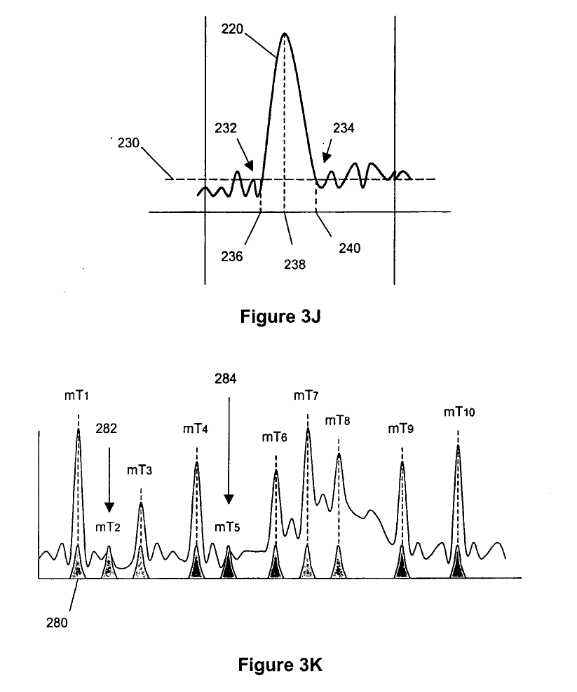

A typical electropherogram (200) displaying electropherogram data is illustrated in FIG. 3A. Several peaks are shown, including a first electrophoretic standard (202) (“std₁”), peaks corresponding to molecular tags mT₁ through mT₆, and a second electrophoretic standard 9204 (“std₂”). Factors that complicate the identification, or correlation, of peaks with molecular tags include noise (205) that may be time dependent, variability between adjacent peaks, or stretching or compressions (208), elevation or variability in the “baseline” signal (206), and the like. As explained more fully below, an object of the present invention is to provide methods for accurately correlating peaks in electropherogram data with molecular tags in view of the above-mentioned distortions in the data. As illustrated in FIG. 3B, in one aspect, the invention provides measures of peak locations relative to the positions of one or more electrophoretic standards. In particular, a migration time T₃ (252) for a molecular tag, “mT₃”, is provided as the following ratio:
T₃=(t₃−Tₛ₁)/(Tₛ₂−Tₛ₁)
where t3 is the observed migration time and Tₛ₁ and Tₛ₂ are the migration times of electrophoretic standards (202) and (204), respectively.

The method of correlating peaks in electropherogram data with molecular tags follows the general steps in FIG. 3C. After electropherogram data is read (290) by a processing unit, peak locations are identified (292) and peak sizes are determined (294). Finally, all or a subset of identified peaks are correlated (296) with molecular tags used in the assay. Preferably, peak size is correlated to the amount of analyte in a sample. A variety of measures may be used for peak size, including peak height, peak area, or the like. Preferably, peak area is used as a measure of peak size. Peak area may be estimated is a variety of ways, including taking the product of peak height and peak width at half maximum height, curve fitting, numerical integration of peak areas, and the like.

In one aspect of the invention, two electrophoretic standards are employed, a first electrophoretic standard, e.g. (202) in FIG. 3A, and a second electrophoretic standard, e.g. (204) in FIG. 3A. All other molecular tags used in an assay are selected so that their peaks in electropherogram data falls between the first electrophoretic standard and the second electrophoretic standard, e.g. as illustrated by molecular tags, “mT₁”, “mT₂”, “mT₃”, “mT₄”, “mT₅”, and “mT₆”, shown in FIG. 3A. In other embodiments, more than two electrophoretic standards may be used and the locations of the standards may be among the peaks corresponding to molecular tags, and not necessarily before and after the locations of such peaks.

Another aspect of the invention makes use of the fact that molecular tags are designed to have either predetermined electrophoretic mobilities and optical properties. If sufficient numbers of a particular tag are released in an assay, then that molecular tag may itself serve as an electrophoretic standard for identification of subsequent peaks. This is advantageous because the closer the reference peak or standard is to a peak whose location is being determined, the more accurate the value for the peak location. As used herein, the term “qualified peak” refers to a peak in electropherogram data that is correlated to a particular molecular tag and that fulfills predetermined criteria for use as an electrophoretic standard. Such criteria may include a measure for peak signal-to-noise ratio, absolute peak height, peak width, or the like. Preferably, a peak is a qualified peak if the peak signal-to-noise ratio is greater than or equal to 1.5; and more preferably, 2.0; and still more preferably, 2.5. In this embodiment, the accuracy of peak identification may vary according to the presence or absence of analytes in a sample because all, some, or none of the molecular tags may be released in detectable amounts, thereby giving rise to a greater or lesser number of available standards.

In another aspect of the invention, illustrated in FIG. 3K, each molecular tag serves as its own standard for identifying peak locations. The figure shows an electropherogram having ten peaks, mT₁ through mT₁₀. Each of the peaks comprises signal contributions from molecular tags released in the assay and molecular tag standards (280). As shown with molecular tags, mT₂ (282) and mT₅ (284), when no molecular tag is released in the assay, then the observed peak is entirely due to the standard, which is present in a known and detectable quantity.

### Peak Identification and Correlation

After an electropherogram data set is read by a processor, each peak in the data is identified, or located, by a single migration time. In the process of identifying peaks, conventional smoothing or filtering algorithms may be applied to remove noise and outlying data points that have no physical relevance, e.g. using moving average filters, Savitzky-Golay filters, or the like. Algorithms for such filters are disclosed in the following references: Numerical Recipes in C: The Art of Scientific Computing (Cambridge University Press, Cambridge, 1992); Hamming, Digital Filters, Second Edition (Prentice-Hall, Inc., Englewood Cliffs, N.J., 1983); and the like. Conventional peak identification algorithms may be employed to determine the locations and sizes of all peaks in the electropherogram data. A preferred peak identification algorithm is disclosed more fully below. As illustrated in FIG. 3D, the number of peaks identified may be larger than the number of molecular tags used in an assay. In the example of FIG. 3D, 22 peaks are identified, while only six molecular tags are used in the assay. Since the molecular tags and standards are predetermined molecules, their migration times under standardized conditions may be determined beforehand empirically. Thus, for each molecular tag, an interval may be defined (referred to herein as a “migration interval”), as illustrated in FIG. 3D by the shaded rectangles below the electropherogram. The width of the migration interval may be defined in a variety of ways. For example, the center of each interval may correspond to an empirically determined mean value, referred to herein as the “empirical migration time” (shown as a vertical line in the shaded rectangles in the Figure), and the width of the interval may be taken as twice the standard deviation, optionally multiplied by a user-defined value. Peaks whose locations fall outside of the migration intervals may be disregarded, as illustrated in FIG. 3E. In some intervals, e.g. (217) and (219), more than one peak location may be identified. The present invention provides a method for selecting among such peaks to make a correct correlation with a molecular tag.

In one embodiment of the invention, after all peaks are identified, a first electrophoretic standard is identified by determining the first peak that satisfied a set of necessary conditions based on known properties of the compound used as the standard, e.g. optical properties (it may be a different color than the molecular tags), quantity, known range of absolute migration times for the system used for electrophoretic separation and upon transformation, or the like. Preferably, a first electrophoretic standard is determined based on (i) the location of a peak within an empirically determined range, (ii) peak height exceeding a predetermined minimum value, and (iii) peak area exceeding a predetermined minimum value. In a preferred embodiment of the invention, a second electrophoretic standard is employed that has a longer migration time than any of the molecular tags employed in an assay, so that upon separation and transformation an electropherogram is produced similar to that illustrated in FIGS. 3A and 3B. Once the locations of both standards are determined, in one embodiment, migration times of molecular tags are determined as fractions of the interval defined by the two standards, as illustrated in FIG. 3B.

When multiple peaks have locations within the same migration interval, as illustrated in FIG. 3E, several methods may be employed to select a peak correlated with the molecular tag associated with the migration interval. In one embodiment, the location of each candidate peak is first determined relative to the first and second electrophoretic standards in a transformed electropherogram. For example, in as illustrated in FIG. 3F, two peaks are located at t₂₁ and t₂₂ within the migration interval centered at empirically determined, T₂. The following values are determined:
S₁=(t₂₁−Tₛ₁)/(Tₛ₂−Tₛ₁)
S₂=(t₂₂−T₁)/(Tₛ₂−Tₛ₁)
The ratio, S₁ or S₂, that is closest to the ratio of the empirically determined migration time, T₂, and the difference between the migration times of the standards, that is, T₂/(Tₛ₂−Tₛ₁), determines which candidate peak is correlated to the molecular tag of the migration interval.

In another embodiment, the location of each candidate peak is first determined relative to second electrophoretic standard and the previously determined peak location correlated with a molecular tag. For example, in as illustrated in FIG. 3F, two peaks are located at t₂₁ and t₂₂ within the migration interval centered at empirically determined, T₂. The following values are determined:
S′₁=(t₂₁−T₁)/(Tₛ₂−T₁)
S′₂=(t₂₂−T₁)/(Tₛ₂−T₁)
The ratio, S′₁ or S′₂, that is closest to the ratio of the empirically determined migration time, T₂, and the difference between the migration times of the second standard and T₁, that is, T₂/(Tₛ₂−T₁), determines which candidate peak is correlated to the molecular tag of the migration interval. In this embodiment, as peak locations are successively correlated to molecular tags, the most recent such identified migration time is used to select the next migration time when multiple peak locations are present in a migration interval. When no, or low levels of, molecular tag is generated in an assay, a corresponding peak may have a low signal-to-noise ratio and its location may be difficult to identify accurately. Therefore, for a peak location to be used as a standard, preferably such a peak has a signal-to-noise ratio above a minimal value. In one aspect, the minimum signal-to-noise ratio is at least 1.5, and preferably, at least 2.0, and more preferably, 2.5.

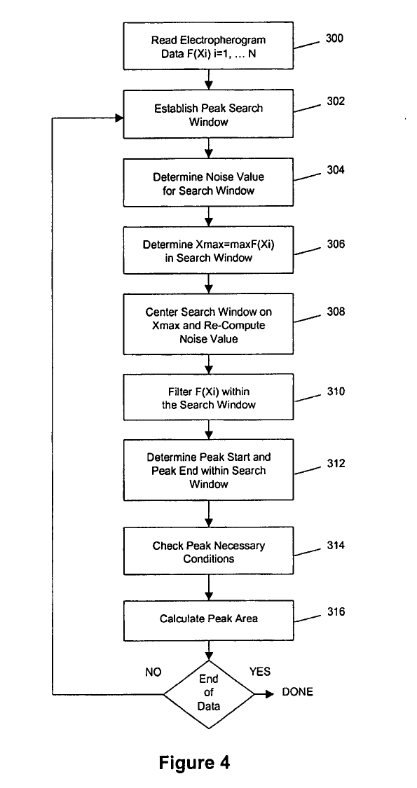

As mentioned above, peaks may be identified in electropherogram data and transformed electropherogram data alike in various ways, e.g. curve fitting, or the like. A preferred algorithm for determining peak location and other parameters, such as, peak height, peak size or area, and peak signal-to-noise ratio, is illustrated in FIGS. 3G to 3J and the flowchart of FIG. 4. As shown in FIG. 30, a peak search window (210) is established having width (212). Window (210) scans (214) the entire data set by starting at the earliest (leftmost) time points, then after carrying out peak detection and analysis steps, the window (212) is shifted to the right a predetermined amount to an overlapping set of times for again carrying out the peak detection and analysis steps. This process continues until all of the data has been analyzed. The width of window (212), the amount shifted in each cycle of peak detection and analysis, are design choices within the ordinary skill in the art. After the position of peak search window (212) is established, a value for the local noise level, that is, the noise level within the search window, is determined as illustrated in FIGS. 3H and 3I. First, an average (222) is taken of all the data values, F(Xᵢ), in the window (220), after which all the data values in excess of the computed average are reduced to the average value (222), shown graphically (223) in FIG. 3I. This process is repeated and a new average value (226) is obtained. Again, data values (224) that exceed the new average (226) are reduced to the value of the new average. The process is repeated until there is effectively no change in the noise value, and the final noise value is taken as the local noise value (230) of the peak search window, as shown in FIG. 3J. Once this value is obtained, the peak location is taken as the ordinate, or migration time value, Xₘₐₓ, that corresponds to the maximum data value, F(Xⱼ), in the peak search window; the peak starting location, tₛₜₐᵣₜ, (236) is the ordinate corresponding to the intersection (232) of the noise level (230) and F(X); the peak ending location, t_{end}, (240) is the ordinate corresponding to the intersection (234) of the noise level (230) and F(X); peak width is the difference between the peak ending and the peak start; and the peak signal-to-noise ratio is the ratio of the peak height, F(Xₘₐₓ), to the noise value (230). Optionally, after the peak location is determined, the noise value may be re-computed (308, FIG. 4) with the peak search window re-centered at Xₘₐₓ. After a peak location is determined, refinements in the baseline value of the local noise may be made. For example, local noise values may be computed adjacent to peak start and peak end points to determine the slope of a baseline of the peak. Such a value may then be used in computing a more accurate value of peak area. After such peak parameters are computed, certain necessary conditions (314) must be met before peak area is determined and the next window shift implemented. Necessary conditions include that the peak width does not overlap other peak widths, that the peak width is wider than a pre-set minimum, e.g. no process were implemented to remove spurious spikes and other outlying values from the electropherogram data. Preferably, peak area is determined by calculating the time-normalized area, that is, the value:
PA=E[F(Xᵢ)/Xᵢ] for i=tₛₜₐᵣₜ, t_{end}

### Assays Analyzed by Electrophoretic Separation

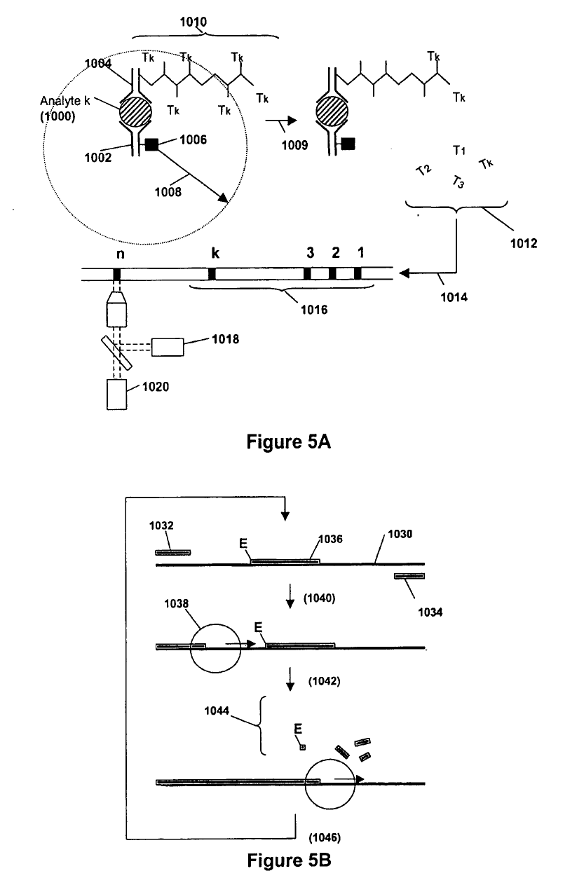

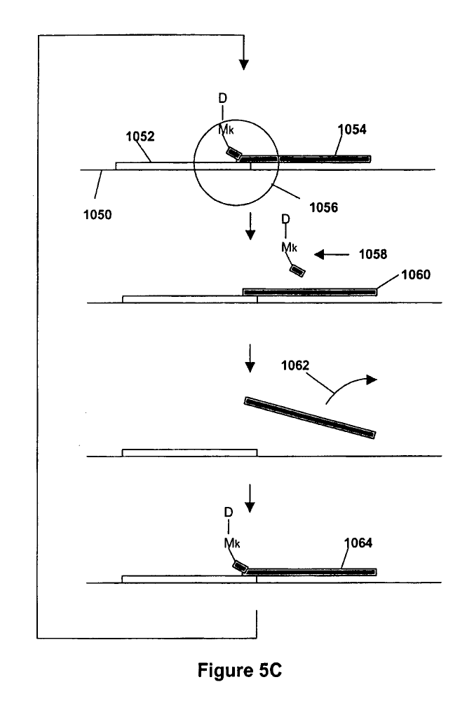

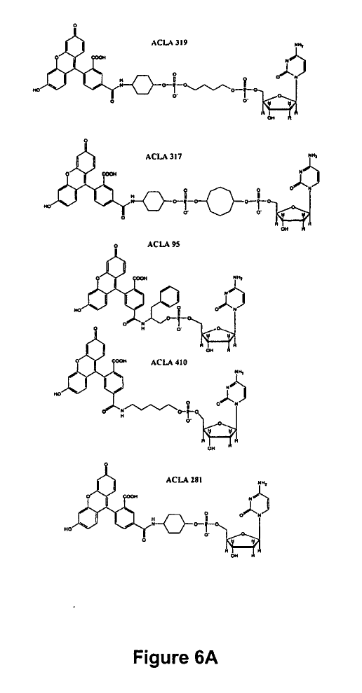

Several types of assays may be employed for generating molecular tags that are analyzed in accordance with the invention, such as those exemplified in FIGS. 5A-5C. In FIG. 5A, the Kth analyte (1000) in a plurality of n analytes in a sample is bound by first binding agent (1002), an antibody in this case, having cleavage-inducing moiety (1006) attached, which in this case is a photosensitizer. Photosensitizer (1006) has an effective proximity (1008) within which singlet oxygen generated by it upon photoactivation can cleave the cleavable linkages holding molecular tags (“Tₖ”) (1010) onto second binding agent (1004). After photoactivation (1009), molecular tags within effective proximity (1008) are released along with molecular tags from other binding complexes to form mixture (1012), which is introduced (1014) into a electrophoretic separation apparatus and separated into distinct bands (1016). Separated tags are detected using conventional detection methodologies. For example, if the molecular tags carry fluorescent labels, then detection occurs after illumination by light source (1020) and collection of fluorescence by detector (1018). Detectable product (1026) is then detected at a detection station as described for FIG. 5A.

In FIG. 5B, a method of generating molecular tags is illustrated that is based on a “taqman” polymerase chain reaction (PCR). While target polynucleotide (1030) is amplified by PCR using primers (1032) and (1034), binding compound (1036) specifically hybridizes (1040) to one strand of the target polynucleotide during primer extension and is degraded by the 5′→3′ exonuclease activity of a DNA polymerase (1038), resulting (1042) in the release of molecular tag (1044)(shown as “D-M-N”). After several cycles (1046), sufficient molecular tag is released to generate a detectable signal after electrophoretic separation. In FIG. 5C, a method of generating molecular tags is illustrated that is based on an “Invader” reaction. Invader probe (1052) and detection probe (1054) specifically hybridize to target polynucleotide (1050) and form a structure that is recognized by a cleavase (1056), after which the nuclease activity of the cleavase releases molecular tag (1058) leaving cleaved detection probe (1060) hybridized to the target polynucleotide. The length and sequence of detection probe (1054) is selected so that there is a rapid replacement (1062) of cleaved detection probe (1060) with uncleaved detection probe (1064), which is present in excess. As above, reaction cycles continue (1066) until sufficient molecular tag is released to generate a detectable signal after electrophoretic separation.

Samples containing analytes may come from a wide variety of sources including cell cultures, animal or plant tissues, microorganisms, or the like. Samples are prepared for assays of the invention using conventional techniques, which may depend on the source from which a sample is taken. Guidance for sample preparation techniques can be found in standard treatises, such as Sambrook et al, Molecular Cloning, Second Edition (Cold Spring Harbor Laboratory Press, New York, 1989); Innis et al, editors, PCR Protocols (Academic Press, New York, 1990); Berger and Kimmel, “Guide to Molecular Cloning Techniques,” Vol. 152, Methods in Enzymology (Academic Press, New York, 1987); Ohlendieck, K. (1996). Protein Purification Protocols; Methods in Molecular Biology, Humana Press Inc., Totowa, N.J. Vol 59: 293-304; Method Booklet 5, “Signal Transduction” (Biosource International, Camarillo, Calif., 2002); or the like. For mammalian tissue culture cells, or like sources, samples containing analytes may be prepared by conventional cell lysis techniques (e.g. 0.14 M NaCl, 1.5 mM MgCl₂, 10 mM Tris-Cl (pH 8.6), 0.5% Nonidet P-40, and protease and/or phosphatase inhibitors as required).

In one aspect of the present invention, sets of molecular tags are provided that may be separated into distinct bands or peaks by electrophoresis after they are released from binding compounds. Molecular tags within a set may be chemically diverse; however, for convenience, sets of molecular tags are usually chemically related. For example, they may all be peptides, or they may consist of different combinations of the same basic building blocks or monomers, or they may be synthesized using the same basic scaffold with different substituent groups for imparting different separation characteristics, as described more fully below. The number of molecular tags in a plurality may vary depending on several factors including the mode of separation employed, the labels used on the molecular tags for detection, the sensitivity of the binding moieties, the efficiency with which the cleavable linkages are cleaved, and the like. In one aspect, the number of molecular tags in a plurality ranges from 2 to several tens, e.g. 50. In other aspects, the size of the plurality may be in the range of from 2 to 40, 2 to 20, 2 to 10, 3 to 50, 3 to 20, 3 to 10, 4 to 50, 4 to 10, 5 to 20, or 5 to 10.

### Binding Compounds and Molecular Tags

An aspect of the invention includes providing mixtures of pluralities of different binding compounds, wherein each different binding compound has one or more molecular tags attached through cleavable linkages. The nature of the binding compound, cleavable linkage and molecular tag may vary widely. A binding compound may comprise a binding moiety, such as an antibody binding composition, an antibody, a peptide, a peptide or non-peptide ligand for a cell surface receptor, a protein, an oligonucleotide, an oligonucleotide analog, such as a peptide nucleic acid, a lectin, or any other molecular entity that is capable of specific binding or complex formation with an analyte of interest. In one aspect, a binding compound, which can be represented by the formula below, comprises one or more molecular tags attached to an analyte-specific binding moiety.
B-(L-E)ₖ
wherein B is a binding moiety; L is a cleavable linkage; and E is a molecular tag. Preferably, in homogeneous assays for non-polynucleotide analytes, cleavable linkage, L, is an oxidation-labile linkage, and more preferably, it is a linkage that may be cleaved by singlet oxygen. The moiety “-(L-E)ₖ” indicates that a single binding compound may have multiple molecular tags attached via cleavable linkages. In one aspect, k is an integer greater than or equal to one, but in other embodiments, k may be greater than several hundred, e.g. 100 to 500, or k is greater than several hundred to as many as several thousand, e.g. 500 to 5000. Within a composition of the invention, usually each of the plurality of different types of binding compound has a different molecular tag, E. Cleavable linkages, e.g. oxidation-labile linkages, and molecular tags, E, are attached to B by way of conventional chemistries.

Once each of the binding compounds is separately conjugated with a different molecular tag, it is pooled with other binding compounds to form a plurality of binding compounds, or a binding composition. Usually, each different kind of binding compound is present in such a composition in the same proportion; however, proportions may be varied as a design choice so that one or a subset of particular binding compounds are present in greater or lower proportion depending on the desirability or requirements for a particular embodiment or assay. Factors that may affect such design choices include, but are not limited to, antibody affinity and avidity for a particular target, relative prevalence of a target, fluorescent characteristics of a detection moiety of a molecular tag, and the like.

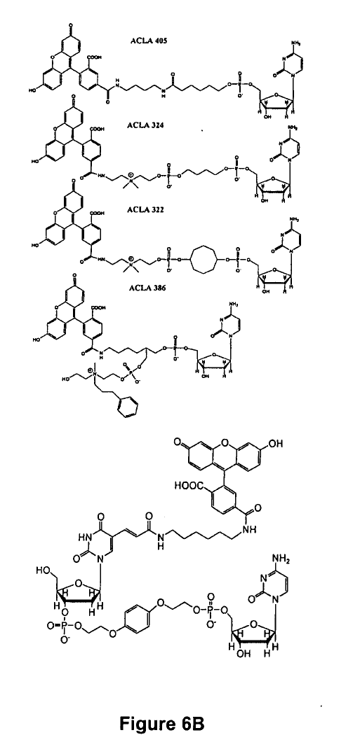

In one aspect, B is an oligonucleotide defined by the following formula:
E-N-T
where E is as defined above, N is a nucleotide, and T is an oligonucleotide specific for a polynucleotide analyte. Preferably, N is attached to the 5′ nucleotide of T by way of a natural phosphodiester bond. E may be attached to N via several different attachment sites, either on the base of N or its ribose or deoxyribose moiety. Preferably, E is attached to the 5′ carbon of N by way of a phosphodiester bond. Synthesis of such compounds is taught in U.S. Pat. Nos. 6,322,980 and 6,514,700, which are incorporated by reference; and in International patent publication WO 01/83502. In this class of binding compound, the cleavable linkage is preferably the phosphodiester bond between N and T, and it is cleaved by way of an enzymatic reaction by a nuclease that recognizes specific structures formed by the binding compound, the target polynucleotide, and possibly other molecular elements. As a result of the enzymatic reaction molecular tag of the form “E-N” are released. Preferably, the enzymatic reaction is in conjunction with an amplification reaction so that in a single assay each target polynucleotide gives rise to many hundreds, or thousands, of released molecular tags. In one aspect, molecular tags may be generated by any one of several nucleic acid-based signal amplification techniques that use the degradation of a probe with a nuclease activity, including but not limited to “taqman” assays, e.g. Gelfand, U.S. Pat. No. 5,210,015; probe-cycling assays, e.g. Brow et al, U.S. Pat. No. 5,846,717; Walder et al, U.S. Pat. No. 5,403,711; Hogan et al, U.S. Pat. No. 5,451,503; Western et al, U.S. Pat. No. 6,121,001; Fritch et al, U.S. Pat. No. 4,725,537; Vary et al, U.S. Pat. No. 4,767,699; and other degradation assays, e.g. Okano and Kambara, Anal. Biochem., 228: 101-108 (1995). Exemplary released molecular tags of this embodiment are illustrated in FIGS. 6A and 6B. In this embodiment, released molecular tags preferably have the form “(M, D)-N”, where the moiety “(M, D)” is defined as described below.

In another aspect, B is an antibody binding composition. Such compositions are readily formed from a wide variety of commercially available antibodies, both monoclonal and polyclonal, specific for a wide variety of analytes. Extensive guidance can be found in the literature for covalently linking molecular tags to binding compounds, such as antibodies, e.g. Hermanson, Bioconjugate Techniques, (Academic Press, New York, 1996), and the like. In one aspect of the invention, one or more molecular tags are attached directly or indirectly to common reactive groups on a binding compound. Common reactive groups include amine, thiol, carboxylate, hydroxyl, aldehyde, ketone, and the like, and may be coupled to molecular tags by commercially available cross-linking agents, e.g. Hermanson (cited above); Haugland, Handbook of Fluorescent Probes and Research Products, Ninth Edition (Molecular Probes, Eugene, Oreg., 2002). In one embodiment, an NHS-ester of a molecular tag is reacted with a free amine on the binding compound.

When L is oxidation labile, L is preferably a thioether or its selenium analog; or an olefin, which contains carbon-carbon double bonds, wherein cleavage of a double bond to an oxo group, releases the molecular tag, E. Illustrative thioether bonds are disclosed in Willner et al, U.S. Pat. No. 5,622,929 which is incorporated by reference. Illustrative olefins include vinyl sulfides, vinyl ethers, enamines, imines substituted at the carbon atoms with an α-methine (CH, a carbon atom having at least one hydrogen atom), where the vinyl group may be in a ring, the heteroatom may be in a ring, or substituted on the cyclic olefinic carbon atom, and there will be at least one and up to four heteroatoms bonded to the olefinic carbon atoms.

Molecular tag, E, is preferably a water-soluble organic compound that is stable with respect to the active species, especially singlet oxygen, and that includes a detection or reporter group. Otherwise, E may vary widely in size and structure. In one aspect, E has a molecular weight in the range of from about 50 to about 2500 daltons, more preferably, from about 50 to about 1500 daltons. Preferred structures of E are described more fully below. E may comprise a detection group for generating an electrochemical, fluorescent, or chromogenic signal. Preferably, the detection group generates a fluorescent signal. Electrophoretic standards of the invention may be selected from the same set of compounds as are the molecular tag. In one aspect, one or more molecular tags in a plurality may be designated and used as electrophoretic standards in the method of the invention. When used as an electrophoretic standard, a known quantity of the molecular tag is added to the mixture to be separated. That is, molecular tags used as electrophoretic standards are not released from a binding compound, they are prepared in their released form and added directly to the mixture to be separated.

Molecular tags within a plurality are selected so that each has a unique electrophoretic separation characteristic and/or a unique optical property with respect to the other members of the same plurality. In one aspect, the electrophoretic separation characteristic is migration time under set of standard separation conditions conventional in the art, e.g. voltage, capillary type, electrophoretic separation medium, or the like. In another aspect, the optical property is a fluorescence property, such as emission spectrum, fluorescence lifetime, fluorescence intensity at a given wavelength or band of wavelengths, or the like. Preferably, the fluorescence property is fluorescence intensity. For example, each molecular tag of a plurality may have the same fluorescent emission properties, but each will differ from one another by virtue of a unique migration time. On the other hand, or two or more of the molecular tags of a plurality may have identical migration times, but they will have unique fluorescent properties, e.g. spectrally resolvable emission spectra, so that all the members of the plurality are distinguishable by the combination of molecular separation and fluorescence measurement.

Preferably, released molecular tags are detected by electrophoretic separation and the fluorescence of a detection group. In such embodiments, molecular tags having substantially identical fluorescence properties have different electrophoretic mobilities so that distinct peaks in an electropherogram are formed under separation conditions. Preferably, pluralities of molecular tags of the invention are separated by conventional capillary electrophoresis apparatus, either in the presence or absence of a conventional sieving matrix. Exemplary capillary electrophoresis apparatus include Applied Biosystems (Foster City, Calif.) models 310, 3100 and 3700; Beckman (Fullerton, Calif.) model P/ACE MDQ; Amersham Biosciences (Sunnyvale, Calif.) MegaBACE 1000 or 4000; SpectruMedix genetic analysis system; and the like. Electrophoretic mobility is proportional to q/M^{2/3}, where q is the charge on the molecule and M is the mass of the molecule. Desirably, the difference in mobility under the conditions of the determination between the closest electrophoretic labels will be at least about 0.001, usually 0.002, more usually at least about 0.01, and may be 0.02 or more. Preferably, in such conventional apparatus, the electrophoretic mobilities of molecular tags of a plurality differ by at least one percent, and more preferably, by at least a percentage in the range of from 1 to 10 percent.

In one aspect, molecular tag, E, is (M, D), where M is a mobility-modifying moiety and D is a detection moiety. The notation “(M, D)” is used to indicate that the ordering of the M and D moieties may be such that either moiety can be adjacent to the cleavable linkage, L. That is, “B-L-(M, D)” designates binding compound of either of two forms: “B-L-M-D” or “B-L-D-M.”

Detection moiety, D, may be a fluorescent label or dye, a chromogenic label or dye, an electrochemical label, or the like. Preferably, D is a fluorescent dye. Exemplary fluorescent dyes for use with the invention include water-soluble rhodamine dyes, fluoresceins, 4,7-dichlorofluoresceins, benzoxanthene dyes, and energy transfer dyes, disclosed in the following references: Handbook of Molecular Probes and Research Reagents, 8th ed., (Molecular Probes, Eugene, 2002); Lee et al, U.S. Pat. No. 6,191,278; Lee et al, U.S. Pat. No. 6,372,907; Menchen et al, U.S. Pat. No. 6,096,723; and Lee et al, U.S. Pat. No. 5,945,526. More preferably, D is a fluorescein or a fluorescein derivative.

Other aspects and advantages of the present invention will be understood upon consideration of the following illustrative examples.

### EXAMPLE 1

This example illustrates the use of integrated current to transform an electropherogram to reduce the variation in the identification of electropherogram peak positions. Ninety samples containing a multiplex of ten molecular tags were analyzed by capillary electrophoresis, wherein the molecular tags were each present in varying amounts. The peaks of the tags in the resulting electropherograms were analyzed according to the methods of the present invention and compared with a standard analysis method employing added standards to calibrate the migration such as described by Williams et al. in U.S. Patent Application No. 2003/0170734 A1. For visual clarity in the figures only a section of the electropherograms are presented, however similar conclusions were obtained for all of the analytes as shown below.

Sample solutions containing the ten molecular tags shown in FIGS. 6A and 6B were prepared in 10 μL volumes, also containing 10 mM N-[tris(hydroxymethyl)methyl]-3-aminopropanesulfonic acid (TAPS), 6.25 mM MgCl₂, 0.25% Tween 20 and 0.25% NP-40. The 10 μL samples were transferred to an injection plate and analyzed by capillary electrophoresis using a MegaBACE 1000 (Amersham Biosciences, Piscataway, N.J.). Capillary columns as provided by the manufacturer were charged with POP4 separation matrix (Applied Biosystems, Foster City, Calif.) and a running buffer of 100 mM TAPS. The operating conditions were: injection using 15 kV for 80 s, separation using 15 kV for 60 min, with the temperature held at 30° C. Analytes were detected by laser-induced fluorescence (LIF) using an Ar⁺ ion laser (488 nm) for excitation, with the detector input filtered with a 520 nm (+/−5 nm) band pass filter. The current was recorded with the current measuring unit of the instrument. The fluorescent signal and the current in each capillary were sampled at 1.67 Hz.

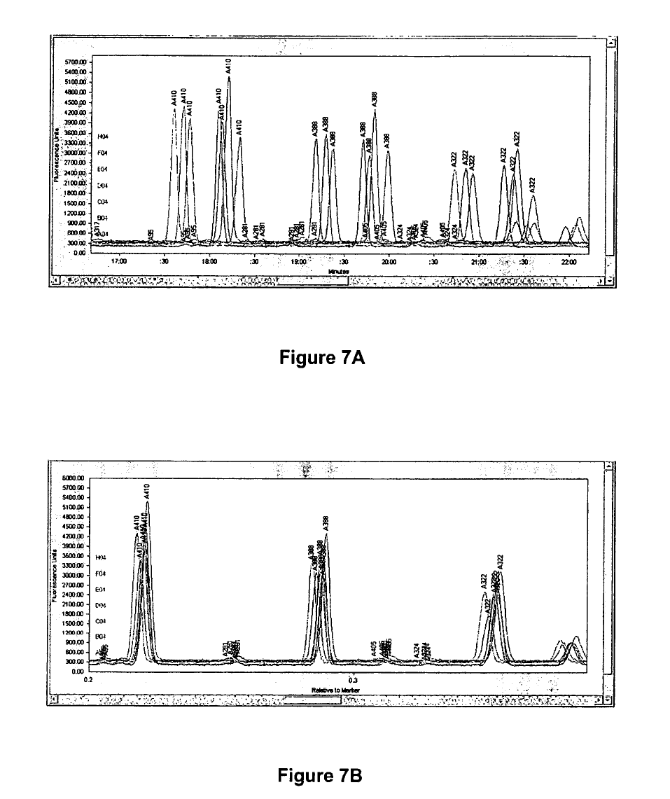

The electrophoretic separation was performed under constant voltage, and the current was recorded as a function of time for each capillary. FIG. 7A shows an expanded section of the electropherograms for seven of the ninety samples represented as the signal versus time. The expanded section features seven peaks associated with seven of the molecular tags. As can be appreciated from the graph, the observed peak position for any of the analytes varies considerably among the electropherograms.

A common method for further improving reproducibility is the inclusion of electrophoretic migration standards, by which the relative migration distance or migration time of the analytes is determined. In this example, two electrophoretic standards that were added to the sample were used to determine the relative peak locations of the analytes. One standard migrated faster than the analytes and was assigned a mobility of 0 (zero), while the other standard migrated slower than the analytes and was assigned a mobility of 1 (one). The peak position of each analyte was interpolated between the standards to determine its relative peak location, expressed as a decimal number between 0.0 and 1.0. FIG. 7B shows an expanded section of the same electropherograms of FIG. 7A, now plotted as the signal versus relative migration time.

In a third method, the electropherogram data sets were analyzed according to one embodiment of the present invention whereby the electropherograms were first transformed to the signal as a function of the cumulative current.

More specifically, to perform the transformation the current recorded during each of the 90 runs was first integrated to provide the cumulative current as a function of time for each run. The integration was performed by summing, for each time point, the recorded, discrete data points of the current as sampled from the beginning of the separation up to that point for each time step:

$${I}_{c} ( t ) = {I}_{0} + {\sum }_{i = 1}^{t} {I}_{i} ; for each t , from t = 1 to t = T$$

where I_{c} is the cumulative current, t is each sampled time point, I₀ is the current at t=0, Iᵢ is the current sampled at the i^{th} time point, and T is the total separation time, to generate a data set of the series of I_{c} as a function of time. Then the signal was graphed as a function of the cumulative current. The electrophoretic standards were identified, assigned respectively the mobility values of 0 and 1, and the relative peak locations of the analytes were determined as usual. FIG. 7C shows the transformed electropherograms as signal versus relative mobility for the same subset of seven runs.

The average and the variation of the observed migration times (MT) of the ten analytes for all of the 90 electropherograms were determined for the three analysis methods as represented in FIGS. 7A-7C and are shown in Table 1. The first method used the uncorrected electropherogram data of signal versus time. The second method used electrophoretic standards to calculate relative migration times. In the third method, the relative migration time was determined for the transformed electropherogram data.

TABLE 1

| | Method | | | | | |
|---|---|---|---|---|---|---|
| | Uncorrected | | | | | |
| | MT [s] | | Relative MT | | Transformed Rel. MT | |
| Analyte | Avg. | (% CV) | Avg. | (% CV) | Avg. | (% CV) |
| A319 | 990.0 | 2.90 | 0.122 | 2.38 | 0.122 | 1.09 |
| A317 | 1030.9 | 2.92 | 0.151 | 2.38 | 0.150 | 1.41 |
| A95 | 1096.7 | 2.91 | 0.197 | 2.50 | 0.196 | 1.05 |
| A410 | 1116.8 | 2.85 | 0.214 | 2.37 | 0.212 | 0.90 |
| A281 | 1166.9 | 2.83 | 0.250 | 2.63 | 0.248 | 0.88 |
| A388 | 1215.8 | 2.87 | 0.287 | 2.32 | 0.283 | 0.73 |
| A405 | 1253.7 | 2.86 | 0.313 | 2.27 | 0.309 | 0.72 |
| A324 | 1276.0 | 2.87 | 0.329 | 2.31 | 0.325 | 0.75 |
| A322 | 1314.4 | 2.86 | 0.357 | 2.16 | 0.352 | 0.66 |
| A386 | 1451.4 | 2.93 | 0.457 | 1.98 | 0.449 | 0.53 |

As demonstrated by the experiment, among the three methods, analysis of the data using the method of transforming the electropherogram provided the smallest coefficient of variation and thus the most consistent determination of the peak migration times (as the relative migration time) across the multiple samples. In particular, the analysis provided by using standards to determine relative migration times, a standard technique in the art, was less reliable, showing a larger variation as evidenced by the higher % CV. The present invention as embodied by transforming the electropherogram based on the cumulative current increased the fidelity of the measurement, and thus the efficiency, accuracy and throughput of such analyses. The improvement of being able to determine peak locations with consistency in electropherograms obtained in different channels or runs is expected to improve the success rate of correlating and thus identifying peaks obtained in electrophoretic separations.

### EXAMPLE 2

This example illustrates the improved capability provided by the present invention of identifying multiple molecular tag analytes in samples analyzed by electrophoresis. Molecular tag analytes were generated in experiments analyzing RNA expression levels in rats using a Rat CYP multiplexed marker panel. Samples of rat liver total RNA isolates were analyzed in four 96-well microtiter plates using the Rat CYP eTag™ (herein referred to as molecular tags) 10-plex assay, which is a multiplexed Invader assay reaction that releases eTag reporter molecules whenever a specified target mRNA is present, e.g. as discussed in Williams et al. U.S. Patent Application No. 2003/0170734 A1.

The multiplexed eTag Invader assay was carried out in accordance with the manufacturer's instructions using a kit obtained from the manufacturer. Briefly, 3 μL of Reaction Mix was dispensed to the wells of a 384-well assay plate, and then 2 μL of Enzyme Mix was added. Samples of 5 μL of total rat liver RNA (150 ng/well) were transferred to the wells of the assay plate. The RNA sample was the pooled total liver RNA of 1000 Sprague-Dawley rats, 8-12 weeks old (Clontech, Palo Alto, Calif.). The plate was sealed with polypropylene self-adhesive film (VWR) and incubated at 60° C. for 16 h.

Following incubation, the plate seal was removed and 10 μL of CE Separation Solution was added to the assay solutions. The solutions were mixed and 10 μL aliquots were transferred to an injection plate and analyzed by capillary electrophoresis using a MegaBACE 1000 (Amersham Biosciences, Piscataway, N.J.). Capillary array columns as provided by the manufacturer were charged with POP4 separation matrix (Applied Biosystems, Foster City, Calif.) and a running buffer of 100 mM N-[tris(hydroxymethyl)methyl]-3-aminopropanesulfonic acid (TAPS). The operating conditions were: injection using 15 kV for 80 s, separation using 15 kV for 60 min, with the temperature held at 30° C. Analytes were detected by laser-induced fluorescence (LIF) using an Ar⁺ ion laser (488 nm) for excitation, with the detector input filtered with a 520 nm (+/−5 nm) band pass filter. The current was recorded with the current measuring unit of the instrument. The fluorescent signal and the current in each capillary were sampled at 1.67 Hz. Thus the electrophoresis was performed at constant voltage, and the time-varying current was recorded in each capillary separation path. The released molecular tag analytes were the set of ten molecular tags illustrated in FIGS. 6A and 6B.

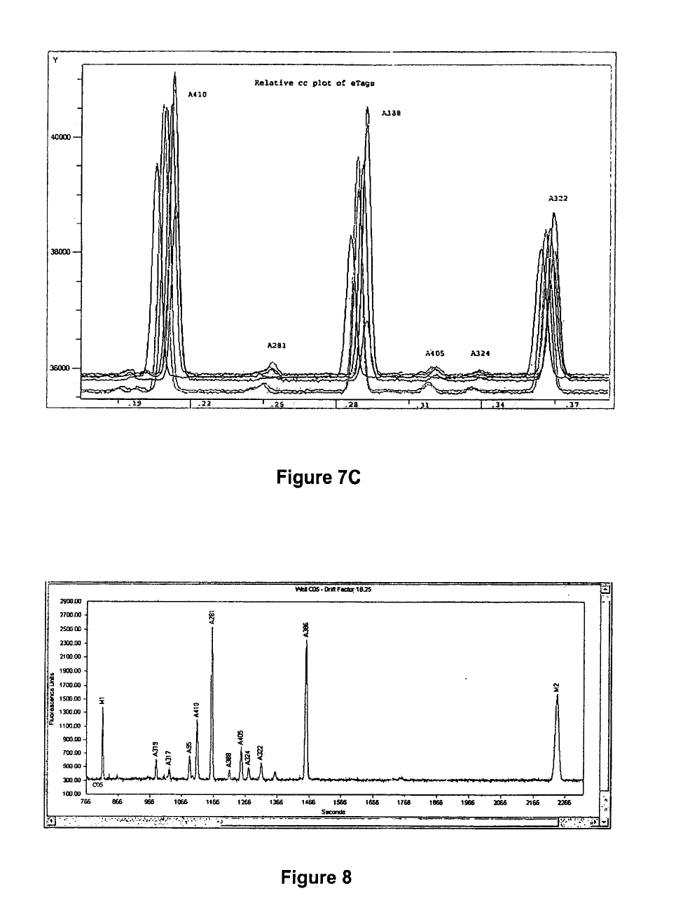

The electropherogram data were analyzed by two methods. In Method 1 the electropherograms were used as collected, i.e. signal intensity as a function of separation time, and in Method 2 the electropherograms were first transformed, as described by the present invention and as described in Example 1, to electropherograms representing the signal intensity as a function of the cumulative current. A representative transformed electropherogram is illustrated in FIG. 8. Then, the electropherograms of each method were analyzed using eTag Informer 2.0 to identify the peaks corresponding to the standards and the molecular tags. Separate databases were created for peak identification by eTag Informer for each analysis method. Thus, the electropherograms of each method were analyzed on the basis of correlation to relative peak locations (with respect to two electrophoretic standards) that were determined using the same conditions and data types.

Table 2 reports the database entries used by eTag Informer for each method for the relative mobility of the 10 molecular tags comprising the Rat CYP kit. The relative peak locations were determined by the manual analysis and averaging of eleven replicate CE runs using the run conditions described above. Also reported are the percentage coefficients of variation for each peak. Although the observed variation is smaller with Method 2, and thus the expected peak location range used by the software is somewhat smaller, a better success rate for identifying the peaks using Method 2 has been demonstrated, as described below.

TABLE 2

Relative Peak
Location (% CV)

| eTag ID | Method 1 | Method 2 |
|---|---|---|
| A319 | 0.115 (1.28) | 0.121 (1.04) |
| A317 | 0.143 (1.31) | 0.151 (1.00) |
| A95 | 0.186 (1.17) | 0.196 (0.96) |
| A410 | 0.202 (1.13) | 0.212 (0.97) |
| A281 | 0.232 (1.02) | 0.244 (0.88) |
| A388 | 0.269 (0.98) | 0.283 (0.88) |
| A405 | 0.294 (0.93) | 0.308 (0.76) |
| A324 | 0.309 (0.91) | 0.325 (0.81) |
| A322 | 0.335 (0.86) | 0.351 (0.72) |
| A386 | 0.365 (0.93) | 0.381 (0.80) |

The results for the four plates run for each of the two methods of analysis are summarized in Table 3 as the total number of peaks observed, the number of those peaks that were accurately identified (called), and the percentage of peaks accurately identified. In some cases the total number of peaks observed is less than the total expected (960=10-plex×96 wells) due to bubbles, injection failures and other mechanical failures. All other peaks were otherwise included in the analysis. As illustrated by the table, in two cases (plates C and D) the data generated by the instrument was distorted to an extant that more than half of the peaks could not be called by Method 1, even despite the fact that the analysis incorporates two electrophoresis standards which flank the set of molecular tag analytes. By contrast, using Method 2 to correct for the local conditions experienced by the sample during the separation, the same samples (plates C and D) were called with a greater than 95% success rate.

Furthermore, Method 2 was demonstrated to not adversely affect the electropherogram data in runs having more normal characteristics. For example, in the runs of plates A and B, local effects such as sample conductivity, temperature, injection plug discontinuity and the like did not significantly perturb the dynamics of the separation process and thus Method 1 provided a useful data analysis. Method 2 still provided a modest improvement in the ability to identify the peaks in plate A, while plate B illustrates the fact that in some instances the older methods are adequate for analysis.

TABLE 3

| | Multiwell Sample Plate ID | | | | | | | |
|---|---|---|---|---|---|---|---|---|
| | Plate A | | Plate B | | Plate C | | Plate D | |
| | Meth. 1 | Meth. 2 | Meth. 1 | Meth. 2 | Meth. 1 | Meth. 2 | Meth. 1 | Meth. 2 |
| No. Peaks | 741 | 741 | 741 | 741 | 910 | 914 | 910 | 914 |
| No. Peaks Called | 658 | 686 | 725 | 722 | 277 | 873 | 418 | 895 |
| % Peaks Called | 88.8 | 92.6 | 97.8 | 97.4 | 30.4 | 95.5 | 45.9 | 97.9 |

This example illustrates that the methods of the present invention may be applied uniformly to electropherogram data sets to improve the fidelity of the information content, such as peak location, of the electropherogram, thus leading to better accuracy, consistency and throughput in the analysis of electrophoretic separations.

All publications and patent applications mentioned in this specification are indicative of the level of skill of those skilled in the art to which this invention pertains. All publications and patent applications set forth herein are incorporated by reference to the same extent as if each individual publication or patent application was specifically and individually indicated to be incorporated by reference.

The invention now having been fully described, it will be apparent to one of ordinary skill in the art that many changes and modifications can be made thereto without departing from the spirit or scope of the appended claims.

What is claimed is:

1. A method of identifying one or more analytes in a sample by electrophoretic separation, the method comprising the steps of:
applying a potential across a separation path containing one or more analytes to generate a current therein and to separate the one or more analytes so that a first electropherogram of a signal as a function of time is produced;
integrating the current with respect to time to provide a cumulative current as a function of time;
transforming the first electropherogram to a second electropherogram of the signal as function of the cumulative current; and
identifying in the second electropherogram peaks that are correlated with the one or more analytes in the sample.

2. The method according to claim 1, wherein said potential is constant.

3. The method according to claim 1, wherein said potential varies with time, and wherein said second electropherogram is a function further comprised of said potential as a function of time.

4. The method according to claim 3, wherein said potential varies with time such that said current in said separation path is constant.

5. The method according to claim 3, wherein said potential varies with time such that the power in said separation path is constant.

6. The method according to claim 1, wherein said separation path is a capillary tube.

7. The method according to claim 1, further comprising at least one electrophoretic mobility standard in said sample, wherein the at least one electrophoretic standard is used to identify peaks that are correlated with said one or more analytes of said sample.

8. The method according to claim 7, comprising two electrophoretic standards wherein the mobility of the first electrophoretic standard is greater than that of any analyte and the mobility of the second electrophoretic standard is less than that of any analyte in said sample.

9. The method according to claim 8, wherein said one or more analytes are molecular tags, wherein each tag has a different electrophoretic mobility.

10. The method according to claim 9, wherein the presence in said sample of said molecular tags is the result of a specific recognition event with at least one type of biomolecule selected from the group of proteins, antigens, receptors, DNA and RNA.

11. The method according to claim 9 or claim 10, wherein said one or more analytes of said sample is a plurality of said molecular tags, numbering in the range of from 2 to 50.

12. A system for identifying one or more analytes in a sample using electrophoretic separation, the system comprising:
a separation path comprising a separation medium;
a voltage source for applying a potential across the separation path so that a current is generated in the separation path and one or more analytes are separated along the separation path;
a detector positioned along the separation path for recording a first electropherogram of the signal intensity associated with the one or more analytes in the separation path as a function of time; and
a processor comprising software for (a) integrating with respect to time the current in the separation path to provide the cumulative current as a function of time; (b) transforming the first electropherogram to a second electropherogram of the signal intensity associated with the analytes as a function of the cumulative current; and (c) identifying in the second electropherogram peaks that are correlated with the one or more analytes in the sample.

13. The system according to claim 12, wherein said voltage source applies a constant voltage.

14. The system according to claim 12, wherein said voltage source applies a voltage varying with time, and further comprising a voltage recording device for recording the voltage applied across said separation path as a function of time, and said processor further comprising software for transforming said first electropherogram to a second electropherogram of the signal intensity as a function further comprised of the applied potential as a function of time.

15. The system according to claim 14, wherein said voltage source applies a voltage varying in time such that said current in said separation path is constant.

16. The system according to claim 14, wherein said voltage source applies a voltage varying in time such that the power in said separation path is constant.

17. The system according to claim 12, wherein said separation path is a capillary tube.

18. The system according to any one of claims 12 to 17, further comprising a plurality of separation paths.

19. The system according to claim 18, wherein said voltage source applies a potential independently across each of said separation paths.

20. The system according to claim 18, wherein said voltage source applies a potential jointly across said separation paths.
